(19) United States
(12) Patent Application Publication
(10) Pub. No.: US 2020/0406167 A1
(43) Pub. Date: Dec. 31, 2020

(54) PURIFICATION METHODS USING SORBENTS AND PRESSURIZED LOW-POLARITY WATER EXTRACTION

(71) Applicant: Sensient Natural Extraction Inc., Delta (CA)

(72) Inventors: Juan Eduardo Cacace, Delta (CA); Ryan Moss, Delta (CA); Lisa Ranken, Delta (CA); Benjamin Lightburn, Delta (CA)

(21) Appl. No.: 16/644,140

(22) PCT Filed: Sep. 5, 2018
(86) PCT No.: PCT/CA2018/051068

§ 371 Date: Mar. 3, 2020

Related U.S. Application Data
(60) Provisional application No. 62/554,230, filed on Sep. 5, 2017.

(51) Int. Cl. B01D 15/20; B01J 20/26; B01J 20/10; B01J 20/291; B01D 15/42; B01J 20/20; B01D 15/18

(52) U.S. Cl. CPC B01D 15/206; B01J 20/261; B01J 20/267; B01J 20/103; B01J 2220/60; B01D 15/426; B01J 20/20; B01D 15/1864; B01J 20/291

(57) ABSTRACT

A method for separating, purifying, and recovering components from a liquid feedstock. The method steps include (i) commingling the liquid feedstock with a sorbent whereby one or more components in the liquid feedstock are bound onto the sorbent, thereby producing a loaded sorbent; (ii) packing the loaded sorbent into a first temperature-controlled pressure-resistant column; (iii) sealably engaging the first temperature-controlled pressure-resistant column with a supply of water, and cooling equipment for receiving a flow of an eluate from the temperature-controlled pressure-resistant column; (iv) from the supply of water, producing a first flow of PLP water at a first selected temperature; (v) flowing the first flow of PLP water through the temperature-controlled pressure-resistant column thereby producing a first flow of the eluate therefrom, said eluate containing the one or more components; (vi) cooling the first flow of the eluate; and (vii) collecting the cooled first flow of the eluate.

### TECHNICAL FIELD

Various embodiments disclosed herein generally relate to equipment, apparatus, and systems for separating and purifying compounds from solutions containing mixtures of solutes. More specifically, this disclosure pertains to equipment, apparatus, and systems for generation and use of pressurized low-polarity water as a solvent with sorbents for separating solutes from solutions.

### BACKGROUND

Ion-exchange resins and other types of sorbents are widely used in a large variety of high-volume through separation, purification, and decontamination processes. The most common ion-exchange resins are based on cross-linked polystyrenes. Four main types of ion-exchange resins differ in their functional groups. One group of ion-exchange resins is strongly acidic and typically comprises sulfonic acid groups such as sodium polystyrene sulfonate or polyAMPS. A second group of ion-exchange resins is weakly acid and typically comprises carboxylic acid groups. A third group of ion-exchange resins is strongly basic and typically comprises quaternary amino groups such as trimethylammonium groups. The fourth group of ion-exchange resins is weakly basic and typically comprises primary, secondary, and/or tertiary amino groups, such as polyethylene amine. Cation resins and anion resins are the two most common resins used commercial applications. Cation resins attract positively charged ions while anion resins attract negatively charged ions.

Large-scale high-volume commercial separation and/or purification processes using ion-exchange resins can be based on throughput of aqueous solutions, for example for water softening, potable water purification by demineralization, treatment of waste water from industrial processes to remove contaminants and/or heavy metals. Some of the problems associated with high-volume commercial separation and/or purification processes are associated with resin fouling or degradation resulting in the resins not binding and separating target molecules from the inflowing solutions. Consequently, the target molecules are discharged in the eluates. Fouling of ion-exchange resins occurs and other sorbents occurs when inorganic salts and/or organic complexes and/or oxidizing agents bind to and coat the sorbents' particles thereby preventing the sorbents' exposure to and ionic binding with target molecules. As the degree of fouling increases, the pressurized throughput of inflowing solutions may result in formation of channels though out the sorbent bed wherein very little or no capture of target molecules occurs. Different types of strategies may be used to clean fouled sorbents, for example, warm-temperature throughput and backwashing with brines or caustic solutions or acidic solutions to remove different types of fouling molecules. However, such ionic-resin recovery and restoration processes are time-consuming and require large volumes of washing solutions.

Sorbents are also commonly used to separate and recover complex organic molecules from organic solvents. For example, there is considerable interest in extracting phytochemicals from medicinal plants and investigating their potential therapeutic applications. Three classes of phytochemicals are of particular interest for their therapeutic and/or nutritional benefits, i.e., polyphenols, specialty carbohydrates, and glycosides. The current approach to the extraction of plant components is through use of either organic solvents or unpressurized hot water to solubilise and remove these components from plant biomass. It is well-known that hot-water systems tend to be less efficient than organic solvent-based systems and are able to only extract a portion of the potentially available phytochemicals from plant biomass. The organic solvent systems commonly use one or more of ethanol, methanol, ethyl acetate, acetone, hexane, toluene, dichloromethane, chloroform, and other such organic solvents. However, organic solvents are generally toxic and their commercial use requires explosion-proof facilities provided with storage and handling equipment certified for use with toxic and flammable chemicals. Furthermore, solvents may remain in final products as unhealthy trace compounds and their toxic properties raise safety concerns for human consumption.

Regardless of the extraction method used to separate and recover phytochemicals from plant materials, the recovered outputs all contain complex mixtures comprising a wide variety of organic and inorganic molecules. Consequently, various types of separation techniques have been employed to isolate and recover individual types of molecules from complex phytochemical extracts. Examples of suitable techniques include thin-layer chromatography, open-column chromatography based on molecular weight separation or ion-exchange separation, flash chromatography using compressed air to force a solvent through a chromatography column, high-performance thin-layer chromatography, vacuum liquid chromatography, high-performance liquid chromatography, and sequential combinations of these techniques. However, the use of such techniques and equipment is restricted to small laboratory-scale applications and most are unsuitable for scale-up into high-volume high-throughput commercial use for a number of reasons. Scaling the size and utilities of equipment and instruments for some techniques are prohibitively expense. High-volume throughput of organic solvents also results in large volumes of hazardous waste streams that require costly storage and disposal strategies.

### SUMMARY

The present disclosure generally relates to apparatus, systems, and methods for separating, purifying, and recovering components from a liquid feedstock.

One embodiment of this disclosure relates to an apparatus for separating, purifying, and recovering components from a liquid feedstock. The apparatus comprises: (i) an inlet for a water supply; (ii) a pump for pressurizing the water supply to produce a pressurized low-polarity water therefrom; (iii) a pressure-resistant column for receiving and containing therein, sorbent resin beads, said pressure-resistant column in liquid communication with the pump; (iv) a temperature-controlled chamber for receiving and engaging therein, said pressure-resistant column; (v) a cooling equipment for receiving therethrough, a flow of an eluate from the pressure-resistant column; (vi) a receptacle for receiving therein the flow of eluate from the cooling equipment, and (vii) a back-flow valve interposed the pressure-resistant chromatography chamber and the eluate-receiving receptacle.

Another embodiment of this disclosure relates to a system for separating, purifying, and recovering components from a liquid feedstock. The system comprises: (i) an apparatus for producing a pressurized low-polarity water from a water supply; (ii) a temperature-controlled chamber housing a pressure-resistant column, said pressure-resistant column filled with sorbent resin beads loaded with a mixture of compounds, said pressure-resistant column in liquid communication with the pump; (iii) a first conduit interconnecting the apparatus for producing a pressurized low-polarity water and the pressure-resistant column; (iv) a cooling equipment for receiving therethrough, a flow of an eluate from the pressure-resistant column; (v) a second conduit interconnecting the temperature-controlled chamber comprising a pressure-resistant column with the cooling equipment, said second conduit having a back-flow valve to control the flow of eluate therethrough; and (vi) a receptacle for receiving therein the flow of eluate from the cooling equipment.

Another embodiment of this disclosure relates to a system for separating, purifying, and recovering components from a liquid feedstock. The system comprises: (i) an apparatus for producing a pressurized low-polarity water from a water supply; (ii) one or more pressure-resistant jacketed chromatography columns wherein the jackets are configured for communicating with a supply of steam or hot water or cold water, said pressure-resistant jacketed chromatography column filled with sorbent resin beads loaded with a mixture of compounds, said one or more pressure-resistant jacketed chromatography columns in liquid communication with the pump; (iii) a first conduit interconnecting the apparatus for producing a pressurized low-polarity water and the one or more pressure-resistant jacketed chromatography columns; (iv) a cooling equipment for receiving therethrough, a flow of an eluate from the pressure-resistant jacketed chromatography columns; (v) a second conduit interconnecting the one or more pressure-resistant jacketed chromatography columns with the cooling equipment, said second conduit having a back-flow valve to control the flow of eluate therethrough; and (vi) a receptacle for receiving therein the flow of eluate from the cooling equipment.

Another embodiment of this disclosure relates to a method for separating, purifying, and recovering compounds from a mixture of compounds loaded onto sorbent beads, comprising the steps of: (i) commingling a liquid mixture of compounds with a plurality of sorbent beads, thereby loading mixture of compounds onto the plurality of sorbent beads through ionic bonding; (ii) packing the loaded plurality of sorbent beads into a temperature-controlled pressure-resistant column; (iii) sealably engaging the temperature-controlled pressure-resistant column with (a) a supply of pressurized low-polarity water, and (b) a cooling equipment for receiving a flow of an eluate from the temperature-controlled pressure-resistant column; (iv) flowing a supply of pressurized low-polarity water through the temperature-controlled pressure-resistant column thereby producing the flow of eluate therefrom; (v) cooling the flow of eluate; and (vi) collecting the cooled flow of eluate.

### BRIEF DESCRIPTION OF THE DRAWINGS

The present invention will be described in conjunction with reference to the following drawings in which:

FIG. 1 is a schematic drawing showing an example of a bench-scale pressurized low-polarity water extraction system interconnected with chromatography column filled with sorbent beads loaded with a mixture of compounds;

FIG. 2 is a schematic drawing showing an example of a commercial-scale pressurized low-polarity water system interconnected with two chromatography columns filled with sorbent bends loaded with a mixture of compounds;

FIG. 3 is a chart showing the desorption of total phenolic compounds from AMBERLITE® FPX-66 resin with pressurized low-polarity water at 130° C. at 2, 3, and 4 BV/h flow rates as a function of the collected volume of water;

FIG. 4 is a chart showing the recovery of total phenolic compounds during desorption from AMBERLITE® FPX-66 resin with pressurized low-polarity water at 130° C. at a 4 BV/h flow rate as a function of the collected volume of water;

FIG. 5A is a chart showing the desorption and recovery of caffeine, catechins, and total phenolics from AMBERLITE® FPX-66 resin with PLP water eluant at 90° C., 130° C., and 180° C., and FIG. 5B is a chart showing the final concentration of these compounds in the eluates collected during the elutions;

FIG. 6A is a chart showing the desorption and recovery of caffeine, catechins, flavonols, and total phenolics from AMBERLITE® XAD 7HP resin with PLP water eluant at 90° C., 130° C., and 180° C., and FIG. 6B is a chart showing the final concentration of these compounds in the eluates collected during the elutions;

FIG. 7A is a chart showing the desorption and recovery of caffeine, catechins, flavonols, and total phenolics from SEPABEADS® SP 70 sorbent with PLP water eluant at 90° C., 130° C., and 180° C., and FIG. 7B is a chart showing the final concentration of these compounds in the eluates collected during the elutions;

FIG. 8A is a chart showing the desorption and recovery of caffeine, catechins, flavonols, and total phenolics from ZEOLITE® C18 sorbent with PLP water eluant at 90° C., 130° C., and 180° C., and FIG. 8B is a chart showing the final concentration of these compounds in the eluates collected during the elutions;

FIG. 9 is a chart showing the recoveries of caffeine eluted from different sorbents during elution with PLP water;

FIG. 10 is a chart comparing the initial concentration of caffeine in a green tea extract loaded onto different sorbents with the final concentrations of caffeine in eluates collected from different sorbents during elution with PLP water

FIG. 11A is a chart comparing the sequential recoveries of caffeine, flavonols, and catechins from a green tea extract adsorbed onto AMBERLITE® XAD7HP with PLP water at a first temperature of 75° C. and a second temperature of 145° C., and FIG. 11B is a chart comparing the initial concentrations of caffeine, flavonols, and catechins with the concentrations recovered with PLP water at 75° C. and at 145° C.; and

FIG. 12A is a chart comparing the recoveries of caffeine and dry matter from a guarana extract from AMBERLITE® XAD7HP with PLP water at a first temperature of 80° C. and a second temperature of 140° C., and FIG. 12B is a chart comparing the initial concentrations of caffeine and dry matter with the concentrations recovered at the first extraction with PLP water at 80° C. and the second extraction with PLP water at 140° C.

### DETAILED DESCRIPTION

The exemplary embodiments of present disclosure pertain to an apparatus for generating pressurized low-polarity water (PLP) interconnected with one or more pressure-resistant columns, to a system comprising an apparatus for generating pressurized low-polarity water (PLP) and one or more pressure-resistant columns, and use thereof for extraction and recovery of compounds from a mixture of compounds loaded onto sorbent beads.

As used herein, the singular forms “a”, “an”, and “the” include plural references unless the context clearly dictates otherwise.

As used herein, the terms “optional” or “optionally” or “alternatively” mean that the subsequently described apparatus, system, equipment, or material may or may not occur or be present, and that the description includes instances where the apparatus, system, equipment, or material occurs or is present, and instances where it does not occur or is not present.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges, and are also, encompassed within the disclosure, subject to any specifically excluded limit in the stated range. Where the stated range includes one or both of the limits, ranges excluding either or both of those included limits are also included in the disclosure.

As used herein, the term “pressurized low-polarity water”, also referred to herein as “PLP water” means superheated subcritical water. Superheated subcritical water is water that is held by pressure in a liquid state at a temperature higher than its natural boiling point of 100° C. but less than its critical temperature of 374° C. Many of water's anomalous properties are due to very strong hydrogen binding. Over the superheated temperature range, the hydrogen bonds break thereby changing water's properties more than usually expected by increasing temperature alone. The viscosity and surface tension of water drop, and diffusivity increases with increasing temperature. Consequently, water becomes less polar and behaves more like an organic solvent such as methanol or ethanol. Solubility of organic materials and gases increases by several orders of magnitude and the water itself can act as a solvent, a reagent, and a catalyst. The changes in these properties can be manipulated by controllably increasing or decreasing pressure while controllably increasing temperature to just under the critical temperature of 374° C. In some cases, PLP water may be produced by controllably pressurizing water at temperatures lower than its natural boiling point of 100° C., for example, from the range of about 55° C. to about 99.99° C.

As used herein, the term “critical temperature” means the liquid-vapor critical point at which liquid water and its vapor can coexist. At higher temperatures, the water vapor cannot be liquified by pressure alone.

According to one embodiment of the present disclosure, there is provided an apparatus for separating and/or purifying a compound from a mixture of compounds, wherein the apparatus comprises equipment for generating a flow of PLP water, a temperature-controllable pressure-resistant column for containing therein a sorbent loaded with mixtures of compounds, a container for receiving therein an eluate from the temperature-controllable pressure-resistant column, a pressure-resistant conduit interconnecting the PLP equipment with the temperature-controllable pressure-resistant column, and a conduit interconnecting the pressure-resistant column with the eluate-receiving container. For clarity, the PLP water is an eluent for flowing through the temperature-controllable pressure-resistant column.

According to another embodiment of the present disclosure, there is provided a system for separating and purifying a compound from a mixture of compounds, wherein the system comprises a supply of water, equipment for generating a flow of PLP water from the supply of water, a temperature-controllable pressure-resistant column for containing therein a sorbent loaded with mixtures of compounds, a container for receiving therein an eluate from the temperature-controllable pressure-resistant column, a pressure-resistant conduit interconnecting the PLP equipment with the temperature-controllable pressure-resistant column, and a conduit interconnecting the temperature-controllable pressure-resistant column with the eluate-receiving container. For clarity, the PLP water is an eluent for flowing through the temperature-controllable pressure-resistant column.

According to another embodiment of the present disclosure, there is provided a system for separating and purifying a compound from a mixture of compounds, wherein the system comprises a supply of water, equipment for generating a flow of PLP water from the supply of water, a first temperature-controllable pressure-resistant column for receiving and containing therein a selected sorbent, a pressure-resistant conduit interconnecting the PLP equipment with the first temperature-controllable pressure-resistant column, a second temperature-controllable pressure-resistant column for receiving and containing therein a selected sorbent, a pressure-resistant conduit interconnecting the first temperature-controllable pressure-resistant column with the second temperature-controllable pressure-resistant column, a container for receiving therein an eluate from the second temperature-controllable pressure-resistant column, and a pressure-resistant conduit interconnecting second temperature-controllable pressure-resistant chromatography column with the eluate-receiving container. According to one aspect, the system may additionally comprise one or more temperature-controllable pressure-resistant columns for receiving and containing therein a selected sorbent, for example three columns, four columns, five columns, six columns, or more, wherein the first temperature-controllable pressure-resistant column is interconnected to the second temperature-controllable pressure-resistant column with a pressure-resistant conduit, wherein the second temperature-controllable pressure-resistant column is optionally interconnected to the third temperature-controllable pressure-resistant column with a pressure-resistant conduit, wherein the third temperature-controllable pressure-resistant column is optionally interconnected to the fourth temperature-controllable pressure-resistant column with a pressure-resistant conduit, wherein the fourth temperature-controllable pressure-resistant column is optionally interconnected to the fifth temperature-controllable pressure-resistant column with a pressure-resistant conduit, wherein the fifth temperature-controllable pressure-resistant column is optionally interconnected to the sixth temperature-controllable pressure-resistant column with a pressure-resistant conduit. Each of the additional temperature-controllable pressure-resistant columns may be interconnected to a water supply and/or a supply of PLP water. Each of the additional temperature-controllable pressure-resistant columns may be provided with valve-controllable conduit for discharging a flow of eluate therefrom. For clarity, the PLP water is an eluent for flowing through the temperature-controllable pressure-resistant columns. Also note that the PLP equipment can be used to maintain the first and/or second and/or third and/or fourth eluates as PLP eluate while they are flowing through a temperature-controllable pressure-resistant column. “PLP eluate” means superheated subcritical eluate.

According to another embodiment of the present disclosure, there is provided a system for extraction and recovery of components from biomass feedstocks, wherein the system comprises a supply of water, equipment for generating a flow of PLP water from the supply of water, a temperature-controllable pressure-resistant reaction column for receiving and containing therein a biomass feed stock, a temperature-controllable pressure-resistant column for receiving and containing therein a sorbent, a container for receiving therein an eluate from the temperature-controllable pressure-resistant column, a pressure-resistant conduit interconnecting the PLP equipment with the temperature-controllable pressure-resistant reaction column, a pressure-resistant conduit interconnecting the temperature-controllable pressure-resistant reaction column with the temperature-controllable pressure-resistant column, and a pressure-resistant conduit interconnecting the temperature-controllable pressure-resistant column with the eluate-receiving container. According to one aspect, the system may additionally comprise two or more temperature-controllable pressure-resistant columns for receiving and containing therein a selected sorbent, for example three columns, four columns, five columns, six columns, or more, wherein the first temperature-controllable pressure-resistant column is interconnected to the second temperature-controllable pressure-resistant column with a pressure-resistant conduit, wherein the second temperature-controllable pressure-resistant column is optionally interconnected to the third temperature-controllable pressure-resistant column with a pressure-resistant conduit, wherein the third temperature-controllable pressure-resistant column is optionally interconnected to the fourth temperature-controllable pressure-resistant column with a pressure-resistant conduit, wherein the fourth temperature-controllable pressure-resistant column is optionally interconnected to the fifth temperature-controllable pressure-resistant column with a pressure-resistant conduit, wherein the fifth temperature-controllable pressure-resistant column is optionally interconnected to the sixth temperature-controllable pressure-resistant column with a pressure-resistant conduit. Each of the additional temperature-controllable pressure-resistant columns may be interconnected to a water supply and/or a supply of PLP water. Each of the additional temperature-controllable pressure-resistant columns may be provided with valve-controllable conduit for discharging a flow of eluate therefrom. For clarity, the PLP water is an eluent for flowing through the temperature-controllable reaction vessel and the temperature-controllable pressure-resistant column. Also note that the PLP equipment can be used to maintain the first and/or second and/or third and/or fourth eluates as PLP eluate while they are flowing through a temperature-controllable pressure-resistant column. “PLP eluate” means superheated subcritical eluate.

According to another embodiment of the present disclosure, there is provided a method for separating and purifying a compound from a mixture of compounds, wherein the method comprises the steps of:
(i) commingling a solution containing a mixture of compounds with a selected sorbent to bind the compounds to the sorbent thereby loading the sorbent and then washing the loaded sorbent with water one or more times to remove any excess compounds that haven't bound to the sorbent;
(ii) placing the loaded sorbent into the temperature-controllable pressure-resistant column;
(iii) from a flow of water, producing a first flow of PLP water at a first selected temperature with the PLP equipment;
(iv) flowing the PLP water for a selected period of time through the loaded sorbent in the pressure-resistant column; and
(v) collecting an eluate flowing out of the pressure-resistant column.

According to one aspect, the method additionally comprises a step of producing a second flow of PLP water at a second selected temperature with the PLP equipment, and flowing said second flow of PLP water though the loaded sorbent in the pressure-resistant column for a second selected period of time. The method may optionally comprise a step of producing a third flow of PLP water at a third selected temperature with the PLP equipment, and flowing said third flow of PLP water though the loaded sorbent in the pressure-resistant column for a third selected period of time. The method may optionally comprise additional steps of producing additional flows of PLP water at additional temperatures and flowing said PLP water through the loaded sorbent in the pressure-resistant column for additional selected periods of time.

According to another embodiment of the present disclosure, there is provided a method for separating and purifying a compound from a mixture of compounds, wherein the method comprises the steps of:
(i) commingling a solution containing the mixture of compounds with a selected first sorbent to bind the compounds to the first sorbent thereby loading the first sorbent and then washing the loaded sorbent with water one or more times to remove any excess compounds that haven't bound to the first sorbent;
(ii) placing the loaded first sorbent into a first temperature-controllable pressure-resistant column;
(iii) from a flow of water, producing a first flow of PLP water at a first selected temperature with the PLP equipment and flowing said first flow of PLP water through the first temperature-controllable pressure-resistant column thereby producing a first flow of PLP eluate therefrom;
(iv) conditioning a second temperature-controllable pressure-resistant column containing a selected second sorbent by flowing therethrough a supply of water heated to the first selected temperature, said second temperature-controllable pressure-resistant column interconnected to the first temperature-controllable pressure-resistant column;
(v) flowing the first PLP eluate flow discharged from the first temperature-controllable pressure-resistant column into and therethrough the second temperature-controllable pressure-resistant column while maintaining the PLP conditions at the first selected temperature; and
(vi) collecting a second eluate flowing from the second temperature-controllable pressure-resistant column.

According to one aspect, the method may optionally comprise the additional steps of:
(vii) conditioning a third temperature-controllable pressure-resistant column containing a selected third sorbent by flowing therethrough a supply of water heated to the first selected temperature, said third temperature-controllable pressure-resistant column interconnected to the second temperature-controllable pressure-resistant column;
(viii) flowing the second PLP eluate flow discharged from the second temperature-controllable pressure-resistant column into and therethrough the third temperature-controllable pressure-resistant column while maintaining the PLP conditions at the first selected temperature; and
(ix) collecting a third eluate flowing from the third temperature-controllable pressure-resistant column.

According to another aspect, the method may optionally comprise the additional steps of:
(x) conditioning a fourth temperature-controllable pressure-resistant column containing a selected fourth sorbent by flowing therethrough a supply of water heated to the first selected temperature, said fourth temperature-controllable pressure-resistant column interconnected to the third temperature-controllable pressure-resistant column;
(xi) flowing the third PLP eluate flow discharged from the second temperature-controllable pressure-resistant column into and therethrough the fourth temperature-controllable pressure-resistant column while maintaining the PLP conditions at the first selected temperature; and
(xii) collecting a fourth eluate flowing from the fourth temperature-controllable pressure-resistant column.

It is optional if so desired, to raise the temperature in any one of the second or third or fourth temperature-controllable pressure-resistant columns to a second selected temperature for flowing a PLP eluate therethrough. If a second temperature was selected for flowing the first PLP eluate therethrough the second temperature-controllable pressure-resistant column, it is optional if so desired, to raise the temperature in any one of the third or fourth temperature-controllable pressure-resistant columns to a third selected temperature for flowing a PLP eluate therethrough.

According to another embodiment of the present disclosure, there is provided a method for separating and purifying a compound from a mixture of compounds, wherein the method comprises the steps of:
(i) conditioning a temperature-controllable pressure-resistant column containing therein a sorbent by flowing a supply of water therethrough;
(ii) flowing a solution containing a mixture of compounds through the temperature-controllable pressure-resistant column to bind the compounds to the conditioned sorbent thereby loading the sorbent,
(iii) flowing a supply of water through the temperature-controllable pressure-resistant column to remove unbound compounds from the loaded sorbent,
(iv) increasing the temperature of the water supply flowing through the temperature-controllable pressure-resistant column until a selected temperature is reached.
(v) flowing a supply of PLP water heated to the selected temperature through the temperature-controllable pressure-resistant column for a first selected period of time,
(vi) collecting an eluate flowing out of the pressure-resistant column.

According to one aspect, the method may comprise an additional step of heating the supply of PLP water to a second selected temperature and flowing said heated PLP water supply through the temperature-controllable pressure-resistant column for a second selected period of time and collecting an eluant discharged therefrom. If so desired, the method may comprise an additional step of heating the supply of PLP water to a third selected temperature and flowing said heated PLP water supply through the temperature-controllable pressure-resistant column for a third selected period of time and collecting an eluant discharged therefrom. If so desired, the supply of PLP water may be heated to additional selected temperatures wherein each additional selected temperature is flowed through the temperature-controllable pressure-resistant column and an eluant discharged therefrom is collected.

According to another embodiment of the present disclosure, there is provided a method for separating and purifying a compound from a mixture of compounds, wherein the method comprises the steps of:
(i) conditioning a first temperature-controllable pressure-resistant column containing therein a selected first sorbent by flowing a supply of water therethrough;
(ii) flowing a solution containing a mixture of compounds through the first temperature-controllable pressure-resistant column to bind the compounds to the conditioned first sorbent thereby loading the sorbent thereby loading the first sorbent,
(iii) flowing the supply of water through the first temperature-controllable pressure-resistant column to remove unbound compounds from the loaded first sorbent,
(iv) increasing the temperature of the water supply flowing through the first temperature-controllable pressure-resistant column until a selected temperature is reached.
(v) flowing a supply of PLP water heated to the selected temperature through the first temperature-controllable pressure-resistant column for a first selected period of time thereby producing a flow of first eluate therefrom,
(vi) conditioning a second temperature-controllable pressure-resistant column containing a selected second sorbent by flowing therethrough the supply of water heated to the first selected temperature, then flowing a supply of PLP water therethrough, said second temperature-controllable pressure-resistant column interconnected to the first temperature-controllable pressure-resistant column;
(vii) flowing the first PLP eluate flow discharged from the first temperature-controllable pressure-resistant column into and therethrough the second temperature-controllable pressure-resistant column while maintaining the PLP conditions at the first selected temperature; and
(viii) collecting a second eluate flowing from the second temperature-controllable pressure-resistant column.

According to one aspect, the method may optionally comprise the additional steps of:
(ix) conditioning a third temperature-controllable pressure-resistant column containing a selected third sorbent by flowing therethrough a supply of water heated to the first selected temperature, then flowing a supply of PLP water therethrough, said third temperature-controllable pressure-resistant column interconnected to the second temperature-controllable pressure-resistant column;
(x) flowing the second eluate flow discharged from the second temperature-controllable pressure-resistant column into and therethrough the third temperature-controllable pressure-resistant column while maintaining the PLP conditions at the first selected temperature; and
(xi) collecting a third eluate flowing from the third temperature-controllable pressure-resistant column.

According to another aspect, the method may optionally comprise the additional steps of:
(xii) conditioning a fourth temperature-controllable pressure-resistant column containing a selected fourth sorbent by flowing therethrough a supply of water heated to the first selected temperature, then flowing a supply of PLP water therethrough, said fourth temperature-controllable pressure-resistant column interconnected to the third temperature-controllable pressure-resistant column;
(xiii) flowing the third PLP eluate flow discharged from the second temperature-controllable pressure-resistant column into and therethrough the fourth temperature-controllable pressure-resistant column while maintaining the PLP conditions at the first selected temperature; and
(xiv) collecting a fourth eluate flowing from the fourth temperature-controllable pressure-resistant column.

According to one aspect, the method may comprise an additional step of heating the supply of PLP water to a second selected temperature and flowing said heated PLP water supply through the temperature-controllable pressure-resistant column for a second selected period of time and collecting an eluant discharged therefrom. If so desired, the method may comprise an additional step of heating the supply of PLP water to a third selected temperature and flowing said heated PLP water supply through the temperature-controllable pressure-resistant column for a third selected period of time and collecting an eluant discharged therefrom. If so desired, the supply of PLP water may be heated to additional selected temperatures wherein each additional selected temperature is flowed through the temperature-controllable pressure-resistant column and an eluant discharged therefrom is collected.

According to another embodiment of the present disclosure, there is provided a method for extraction and recovery of components from biomass feedstocks, wherein the method comprises the steps of:
(i) loading a biomass feedstock into a temperature-controllable pressure-resistant reaction vessel;
(ii) from a flow of water, producing a supply of PLP water at a first selected temperature with the PLP equipment and flowing said PLP water through the first temperature-controllable pressure-resistant column thereby producing a flow of PLP extract containing therein a mixture of solubilized compounds extracted therefrom the biomass feedstock;
(iii) conditioning a first temperature-controllable pressure-resistant column by flowing a supply of water therethrough at the first selected temperature, then flowing a supply of PLP water therethrough;
(iv) flowing the PLP extract through the first temperature-controllable pressure-resistant column for a first selected period of time while maintaining the PLP conditions at the first selected temperature thereby producing a flow of first eluate therefrom; and
(v) collecting the first eluate.

According to one aspect, the method may optionally comprise the additional steps of:
(vi) conditioning a second temperature-controllable pressure-resistant column containing a selected second sorbent by flowing therethrough the supply of water heated to the first selected temperature, then flowing a supply of PLP water therethrough, said second temperature-controllable pressure-resistant column interconnected to the first temperature-controllable pressure-resistant column;
(vii) flowing the first PLP eluate flow discharged from the first temperature-controllable pressure-resistant column into and therethrough the second temperature-controllable pressure-resistant column while maintaining the PLP conditions at the first selected temperature; and
(viii) collecting a second eluate flowing from the second temperature-controllable pressure-resistant column.

According to another aspect, the method may optionally comprise the additional steps of:
(ix) conditioning a third temperature-controllable pressure-resistant column containing a selected third sorbent by flowing therethrough the supply of water heated to the first selected temperature, then flowing a supply of PLP water therethrough, said third temperature-controllable pressure-resistant column interconnected to the second temperature-controllable pressure-resistant column;
(x) flowing the first PLP eluate flow discharged from the second temperature-controllable pressure-resistant column into and therethrough the third temperature-controllable pressure-resistant column while maintaining the PLP conditions at the first selected temperature; and
(xi) collecting a third eluate flowing from the third temperature-controllable pressure-resistant column.

According to another aspect, the method may optionally comprise the additional steps of:
(xii) conditioning a fourth temperature-controllable pressure-resistant column containing a selected fourth sorbent by flowing therethrough the supply of water heated to the first selected fourth temperature-controllable pressure-resistant column interconnected to the third temperature-controllable pressure-resistant column;
(xiii) flowing the third PLP eluate flow discharged from the third temperature-controllable pressure-resistant column into and therethrough the fourth temperature-controllable pressure-resistant column while maintaining the PLP conditions at the first selected temperature; and
(xiv) collecting a fourth eluate flowing from the fourth temperature-controllable pressure-resistant column.

According to one aspect, the method may comprise an additional step of heating the supply of PLP water to a second selected temperature and flowing said heated PLP water supply through the temperature-controllable pressure-resistant column for a second selected period of time and collecting an eluant discharged therefrom. If so desired, the method may comprise an additional step of heating the supply of PLP water to a third selected temperature and flowing said heated PLP water supply through the temperature-controllable pressure-resistant column for a third selected period of time and collecting an eluant discharged therefrom.

The PLP water may be produced by concurrently applying to a flow of water (i) a pressure from the range of about 100 psi to about 1,300 psi, and (ii) a temperature from the range of about 50° C. to about 370° C. Suitable pressure/temperature combinations are pressures from the range of about 300 psi to 1,000 psi and temperatures from about 60° C. to about 300° C. Particularly suitable pressure/temperature combinations are pressures from the range of about 300 psi to 1,000 psi and temperatures from about 70° C. to about 225° C.

The apparatus, systems, and methods disclosed herein can be used with a variety of types of ion-exchange resins, for example strongly acidic ion-exchange resins or weakly acid ion-exchange resins or strongly basic ion-exchange resins or weakly basic ion-exchange resins. The ion-exchange resins may be either cationic resins or anionic resins.

The apparatus, systems, and methods disclosed herein can be used with a variety of types of sorbents. Suitable sorbents include different sized and pored silica beads for example with 1-8 mm bead diameters, synthetic sodium alumina silicates (also referred to as molecular sieves), silica gels, bonded C₁-C₁₈ silicas, magnesium silicate for example FLORISIL® (FLORISIL is a registered trademark of U.S. Silica Co. Corp., Frederick, Md., USA), activated carbon, bentonite, zirconium oxide, natural zeolites, synthetic zeolites, diatomaceous earths, and the like.

The apparatus, systems, and methods disclosed herein can be used with a variety of types of sorbent resins. Suitable sorbent resins include poly(styrene-divinylbenzene) resins, 100% poly(divinylbenzene (DVB) resins, or crosslinked polyamides, such as those available from SORBTECH Sorbent Technologies Inc. (Norcross, Ga., USA), and the like.

The apparatus, systems, and methods disclosed herein can be used to separate and/or recover and/or purify a wide variety of soluble compounds that comprise ionic charges, for example, metals, rare earths, inorganic ions, organic compounds, phytochemicals, and the like.

It is within the scope of the present disclosure to further process the eluants produced within and collected from the apparatus and systems disclosed herein by the methods disclosed herein, to reduce the volumes of the eluants using apparatus and methods known to those skilled in this art, to produce liquid concentrates. It is also within the scope of the present disclosure to dry the eluants produced within and collected from the apparatus and systems disclosed herein by the methods disclosed herein, using apparatus and methods known to those skilled in this art, to produce powders.

The following examples describing separation of phenolic compounds and catechins from plant extracts are provided for illustration of how the apparatus, systems, and methods of the present disclosure, may be used.

### Example 1: Laboratory-Scale Apparatus for Generating a Flow of PLP Water Through a Chromatography Column

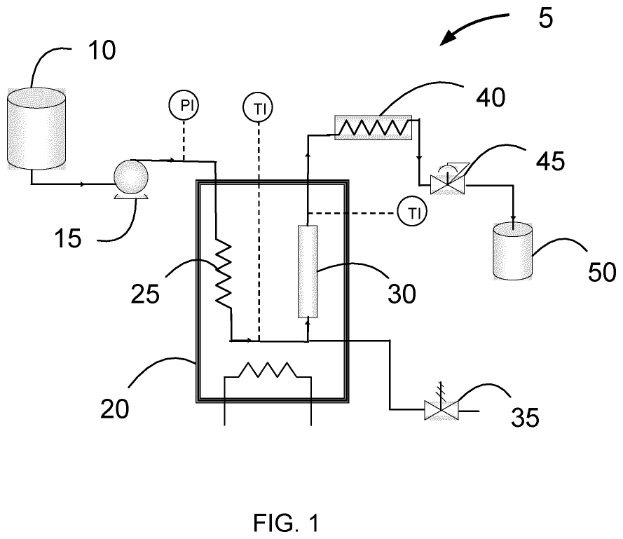

An example of a laboratory-scale system 5 according to one embodiment of the present disclosure is shown in FIG. 1 and generally comprises a water supply 10, a pump 15 (for example, a Waters 515 model, Milford, Mass.), a temperature-controlled oven 20 (for example, a Model 851F, Fisher Scientific, Pittsburgh, Pa.), a preheating coil 25 (for example, 2.0 m stainless steel tubing with 3.2 mm (⅛″) o.d.), a pressure-resistant column 30, a 1.0 m cooling coil 40 (stainless steel tubing with 3.2 mm (⅛″) o.d.), a back-pressure regulator 45 with a cartridge of 5.2 MPa (750 psi) (Upchurch Scientific, Oak Harbor, Wash.) to maintain pressure in the system, and a collection vessel 50. A pressure-relief valve 35 was also provided interposed the preheating coil 25 and the pressure-resistant column 30. Stainless steel tubing (3.2 mm (⅛″) o.d.) and connectors were used to connect the equipment pieces (i.e., the pump, pressure-resistant column, and back-pressure regulator).

### Example 2: Commercial-Scale Apparatus for Generating a Flow of PLP Water Through One or More Large-Scale Chromatography Column(s)

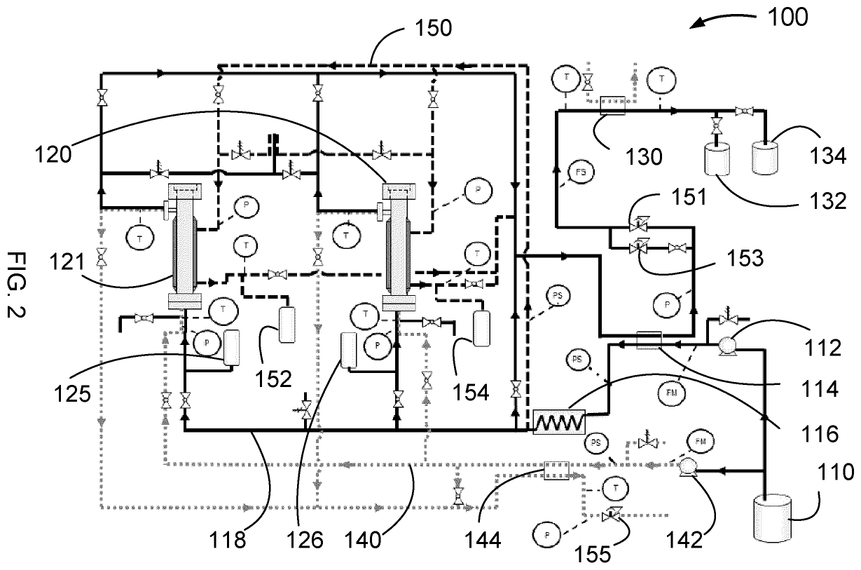

Another exemplary PLPW apparatus 100 interconnected with two large-scale chromatography columns is shown in FIG. 2, wherein the chromatography columns 120, 121 have a maximum operating pressure of 6200 kPa (900 psi) at an operating temperature of 204° C. The column jackets are designed for a lower maximum operating pressure of 2,580 kPa (375 psi) at an operating temperature of 204° C. to prevent crushing of the column if the jacket is pressurized and the column is not. However, because several other pieces of equipment such as the accumulators 125, 126 have been certified for temperatures and pressures less than those of the chromatography columns 120, 121, the maximum operating pressure and temperature of this two-column system, as a whole, is set at 5500 kPa (800 psi) and 180° C., and the maximum operating pressure of the jacket circuit 150 is 2400 kPa (350 psi). The specifications and descriptions for the major parts of the PLPW system shown in FIG. 2 are listed in Tables 1 to 6.

The process flow 118 for the pressurized low-polarity water extraction system is shown in FIG. 2. Process water is drawn from the water reservoir 110 with a positive displacement pump 112 (i.e., a process pump) and passed through heat exchanger 114 where the process water is first used to cool and recover heat from the liquid extract exiting the system. The partially heated water then enters the immersion heater 116, where it is heated to the desired process temperature. The system is controlled to direct the heated water either through the column jackets to warm the equipment, or through the chromatography column 120 packed with a loaded adsorbent to be extracted. The exiting liquid extract/process water flows back through heat exchanger 114 where energy is recovered and the product temperature is lowered to below the boiling point before reaching back-pressure regulator 151. The purpose of the back-pressure regulator 151 is to maintain the system pressure at a point above the saturation pressure at the operating processing temperature to prevent the formation of steam. After back-pressure regulator 151 there is an additional heat exchanger 130 that may be used to control the final temperature of the outgoing liquid extract/process water. This heat exchanger 130 is connected to another water source, whereby the flow can be adjusted by a valve to cool the exiting liquid to the desired temperature. The liquid extract/process water is directed to either the collection vessel 132 or waste water vessel 134 for use elsewhere in the process.

There are several flow circuits within the extraction system. The flow circuit is selected with the automated control system, which controls the valve sequencing to operate each circuit.

### Hot Bypass Circuit:

The hot bypass circuit isolates the chromatography columns 120, 121 and jackets from the rest of the PLPW apparatus. The process pump 112 passes water from the water reservoir 110 through heat exchanger 114 (input side), the immersion heater 116, through the bypass valve BVH, heat exchanger 114 (product side), back-pressure regulator 151, heat exchanger 130, and out of the system to the waste water vessel 134. The purpose of the hot bypass circuit is to pressurize and maintain the system pressure, and to adjust the process water temperature before the water is introduced into the other circuits.

### Warming Circuit:

The warming circuit pushes process water through the chromatography column jackets. The process pump 112 passes water through the input side of heat exchanger 114, the immersion heater 116, the column jacket, the output side out heat exchanger 114, through LPV and back-pressure regulator 153, heat exchanger 130, and out of the system to the waste water vessel 134. The purpose of this circuit is to warm the chromatography column 120 to the desired processing temperature in order to minimize the loss of heat from the processing water to the equipment during extraction. It is to be noted that this circuit could be separated from the other circuits and run independently. This is accomplished by adding another pump (not shown), heat exchanger (not shown), and immersion heater (not shown). Alternatively, the jackets may be converted to use steam from a utilities facility either with steam as the heating medium within the jacket, or through the use of a heat exchanger and water pump to indirectly heat water for the jacket.

### Processing:

During the processing circuit, the process water flows through the chromatography column (e.g., 120 or 121) packed with an adsorbent loaded with a mixture of compounds. The process pump 112 pushes water through the input side of heat exchanger 114, the immersion heater 116, the column 120 or 121, the product side of heat exchanger 114, back-pressure regulator 131, heat exchanger 130, and out of the PLPW apparatus to the collection vessel 732. The purpose of the processing circuit is to solubilise and extract components from PLP extracts that were bound to the adsorbents packed into the chromatography columns 120, 121. The PLP water travels through the chromatography column 720 or 721 from its bottom to its top in a single pass. The least concentrated PLP water first passes through the most extracted adsorbent, thus maximizing the amount of product extracted. In addition, due to the continuous flow-through nature of the extraction system, product is constantly removed from the system with low residence times while exposed to the operating conditions, thus reducing the amount of potential product degradation.

### Cooling Circuit:

The cooling circuit cools the chromatography columns 120, 121 down after the compounds bound to the adsorbents have been fully extracted. Water in the first cooling circuit 140 is taken from the water reservoir 110 or waste water vessel 134 and pumped by the cooling pump 142 through the input side of heat exchanger 144, the bypass valve BVC, and back through the product side of heat exchanger 144, back-pressure regulator 45 and out of the PLPW apparatus to a drain. The purpose of first cooling circuit 40 is to pressurize and maintain the system pressure in the cooling circuit equal to the column pressure from the extraction.

In the second cooling circuit, the PLP water flows through the chromatography column 120 or 121 packed with the spent (i.e., extracted) adsorbent whereby the cooling pump 142 flows water through the input side of heat exchanger 144, the reaction column 120 or 121, the product side of heat exchanger 144, back-pressure regulator 155, and out of the PLPW apparatus into the drain. The purpose of the second cooling circuit is to lower the temperatures of the extracted adsorbent and the chromatography column 120 or 121 below the saturation temperature to allow for safe removal of the extracted adsorbent. Once the temperature is low enough, the PLPW apparatus can be switched back to the first cooling circuit, the chromatography column can be drained of water, the extracted adsorbent removed, and chromatography column can be filled with fresh loaded adsorbent for the next extraction.

It is to be noted that those skilled in these arts will be able to adjust and/or modify the various equipment options disclosed herein for producing a PLPW apparatus that comprises at least two chromatography columns wherein each chromatography column is provided with piping infrastructures communicating with at least a water supply, one or more heaters or heat exchangers for heating the water, and pumps for pressurizing the water to a temperature in the range of about 50° C. to about 65° C., from about 50° C. to about 85° C., from about 50° C. to about 100° C., from about 50° C. to about 125° C., from about 55° C. to about 150° C., from about 55° C. to about 175° C., from about 55° C. to about 185° C., from about 55° C. to about 195° C., from about 55° C. to about 205° C., from about 55° C. to about 225° C., from about 55° C. to about 250° C., from about 55° C. to about 275° C., from about 55° C. to about 300° C., from about 55° C. to about 325° C., from about 55° C. to about 350° C., from about 55° C. to about 375° C., from about 55° C. to about 400° C., and therebetween, and a pressure from the range of about 100 psi to about 500 psi, from about 125 psi to about 450 psi, from about 150 psi to about 400 psi, from about 165 psi to about 375 psi, from about 175 psi to about 350 psi, from about 175 psi to about 325 psi, from about 175 psi to about 300 psi, from about 175 psi to about 275 psi, from about 175 psi to about 250 psi, from about 175 psi to about 225 psi, and therebetween.

TABLE 1
Properties of a two-column PLPW apparatus

| Characteristic | Biomass capacity (35 kg; 46% | |
|---|---|---|
| Inner diameter | 20 | cm |
| Length | 203 | cm |
| Column volume | 65,700 | cm³ |
| Sample mass (dry | 18,900 | g |
| Bed depth | 162 | cm |
| Sample volume | 52,400 | cm³ |
| Sample bulk density | 0.33 | g/cm³ |
| Length to diameter ratio* | 5.4:1 | |
| Solvent: solid ratio | 7.5 | mL/g |
| Volume collected | 142,000 | mL |
| Flow rate | 4,000 | mL/min |
| Superficial velocity | 13.4 | cm/min |
| Residence time** | 12.1 | min |
| Extraction time*** | 30.0 | min |

*where length = bed depth
**residence time = bed depth/superficial velocity
***extraction time = volume collected/flow rate

TABLE 2
Electrical equipment for a two-column PLPW apparatus.

| Name | Power | | Voltage/Phase/Freq | Specification |
|---|---|---|---|---|
| Process Pump | 2 | HP | 208 V/3Φ/60 Hz | Hydra-Cell M03 with 2 hp Baldor motor, |
| | | | | Baldor VFD, Hydra-Cell C62 pulsation |
| | | | | dampener |
| Cooling Pump | 2 | HP | 208 V/3Φ/60 Hz | Hydra-Cell M03 with 2 hp Baldor motor, |
| | | | | Baldor VFD, Hydra-Cell C62 pulsation |
| | | | | dampener |
| Immersion Heater w/Panel | 123 | kW | 600 V/3Φ/60 Hz | Wattco model#MFLS15123X1050-TM |
| Actuators (QTY 18) | 24 | VDC | TBD/TBD/TBD | Promation P1-24N4 |

| | | | |
|---|---|---|---|
| System Control Panel | N/A | 120/208 V/3Φ/60 Hz | Harlok/Cedarcore custom panel, includes |
| | | | parts and labour |

TABLE 3
Heat exchangers for a two-column PLPW apparatus.

| Name | Description | Specification |
|---|---|---|
| Heat Exchanger 1 | Warming Circuit (recovery) | Sentry model# WSW8221U Special |
| Heat Exchanger 2 | City Water (safety) | Sentry model# DTC-SSB/SSD-8-1-1 |
| Heat Exchanger 3 | Cooling Circuit (recovery) | Sentry model# WSW8221U Special |

TABLE 4
Valves for a two-column PLPW apparatus.

| Name | Description | Specification |
|---|---|---|
| BVH | Heating Circuit Bypass Valve | MAS G-3-HD-FS |
| BVC | Cooling Circuit Bypass Valve | MAS G-3-HD-FS |
| ICV1 | Cooling Circuit Inlet Valve, Column 1 | MAS G-3-HD-FS |
| ICV2 | Cooling Curcuit Inlet Valve, Column 2 | MAS G-3-HD-FS |
| IHV1 | Heating Circuit Inlet Valve, Column 1 | MAS G-3-HD-FS |
| IHV2 | Heating Circuit Inlet Valve, Column 2 | MAS G-3-HD-FS |
| OCV1 | Cooling Circuit Outlet Valve, Column 1 | MAS G-3-HD-FS |
| OCV2 | Cooling Circuit Outlet Valve, Column 2 | MAS G-3-HD-FS |
| OHV1 | Heating Circuit Outlet Valve, Column 1 | MAS G-3-HD-FS |
| OHV2 | Heating Circuit Outlet Valve, Column 2 | MAS G-3-HD-FS |
| JIV1 | Jacket Inlet Valve, Column 1 | MAS G-3-HD-FS |
| JOV1 | Jacket Outlet Valve, Column 1 | MAS G-3-HD-FS |
| JIV2 | Jacket Inlet Valve, Column 2 | MAS G-3-HD-FS |
| JOV2 | Jacket Outlet Valve, Column 2 | MAS G-3-HD-FS |
| CWV | Cooling Water Valve | MAS G-3-HD-FS |
| CVV | Collection Vessel Valve | MAS G-3-HD-FS |
| WWV | Waste Water Valve | MAS G-3-HD-FS |
| LPV | Low Pressure Valve (Jacket Operating) | MAS G-3-HD-FS |
| DV1 | Drain Valve, Column 1 | MAS G-3-HD-FS |
| DV2 | Drain Valve, Column 2 | MAS G-3-HD-FS |

TABLE 5
Mechanical regulators and safety valves for a two-column PLPW apparatus.

| Name | Specification | Pressure Setting |
|---|---|---|
| Back Pressure Regulator A | Equilibar EB2NL2 | <750 psi (from nitrogen reference) |
| Back Pressure Regulator B | Equilibar EB2NL2 | <750 psi (from nitrogen reference) |
| Back Pressure Regulator C | Equilibar EB2NL2 | <350 psi (from nitrogen reference) |
| Pressure Regulating Valve PP | Hydra-Cell C62 | 750 psi < Set Point > 800 psi |
| Pressure Regulating Valve CP | Hydra-Cell C62 | 750 psi < Set Point > 800 psi |
| Pressure Relief Valve R1 | Consolidated 19000 Series | 850 psi |
| Pressure Relief Valve R2 | Consolidated 19000 Series | 850 psi |
| Pressure Relief Valve J1 | Consolidated 19000 Series | 350 psi |
| Pressure Relief Valve J2 | Consolidated 19000 Series | 350 psi |
| Pressure Relief Valve IH | Consolidated 19000 Series | 850 psi |
| Accumulator A | Blacoh H2420A | 750 psi |
| Accumulator B | Blacoh H2420A | 750 psi |
| Accumulator C | Blacoh H2420A | 350 psi |
| Accumulator D | Blacoh H2420A | 350 psi |

TABLE 6
Instrumentation for a two-column PLPW apparatus.

| Name | Description | Specification |
|---|---|---|
| FM(H) | Process Flowmeter, Process Circuit | Burkert 8619 controller, SE30 |
| | | sensor and gear fitting |
| FM(C) | Process Flowmeter, Cooling Circuit | Burkert 8619 controller, SE30 |
| | | sensor and gear fitting |
| FS(H) | Flow Switch, Process Circuit | Burkert tuning fork 560986 |
| PCO(J) | Pressure Switch, Warming (Jackets) | United Electric H100 |
| | Circuit | |
| PCO(H) | Pressure Switch, Processing Circuit | United Electric H100 |
| PCO(C) | Pressure Switch, Cooling Circuit | United Electric H100 |
| P(C1) | Pressure, Column 1 | Wika, 233.53 gauge, 2½″ |
| IT(C1) | Inlet Temperature, Column 1 | Trident PD743 meter, WESC12C29- |
| | | 3E03.00C1A RTD |
| OT(C1) | Outlet Temperature, Column 1 | Trident PD743 meter, WESC12C29- |
| | | 3E03.00C1A RTD |
| P(J1) | Pressure, Jacket 1 | Wika, 233.53 gauge, 2½″ |
| T(J1) | Temperature, Jacket 1 | Trident PD743 meter, WESC12C29- |
| | | 3E03.00C1A RTD |
| P(C2) | Pressure, Column 2 | Wika, 233.53 gauge, 2½″ |
| IT(C2) | Inlet Temperature, Column 2 | Trident PD743 meter, WESC12C29- |
| | | 3E03.00C1A RTD |
| OT(C2) | Outlet Temperature, Column 2 | Trident PD743 meter, WESC12C29- |
| | | 3E03.00C1A RTD |
| P(J2) | Pressure, Jacket 2 | Wika, 233.53 gauge, 2½″ |
| T(J2) | Temperature, Jacket 2 | Trident PD743 meter, WESC12C29- |
| | | 3E03.00C1A RTD |
| ET(C) | Outlet Temperature, Cooling Circuit | Trident PD743 meter, WESC12C29- |
| | | 3E03.00C1A RTD |
| BP(H) | Back Pressure, Process Circuit | Wika, 233.53 gauge, 2½″ |
| BP(C) | Back Pressure, Cooling Circuit | Wika, 233.53 gauge, 2½″ |
| IT(HE2) | Inlet Temperature, Heat Exchanger 2 | Trident PD765 meter, WESC12C29- |
| | | 3E03.00C1A RTD |
| OT(HE2) | Outlet Temperature, Heat Exchanger 2 | Trident PD743 meter, WESC12C29- |
| | | 3E03.00C1A RTD |

### Example 3: Assessment of PLP Water-Desorption of Sorbent Resins

The following food-grade sorbents were used in the examples disclosed herein:
an acrylic polymer, AMBERLITE® XAD7HP (AMBERLITE is a registered trademark of Rohm and Haas Company Corp., Philadelphia, Pa., USA),
a PS-DVB resin, AMBERLITE® FPX66,
a PS-DVB copolymer resin, SEPABEADS® SP700 (SEPABEADS is a registered trademark of Mitsubishi Chemical Corp., Tokyo, Japan),
a polymethacrylate resin, DIAION® HP2MG (DIAION is a registered trademark of Mitsubishi Chemical Corp., Tokyo, Japan),
a chemically modified PS-DVB polymer resin, SEPABEADS® SP70,
an irregular silica gel, ZEOPREP 60 (ZEOPREP is a registered trademark of Zeochem AG Aktiengesellschaft, Uetikon am See, Switzerland), and
activated carbon (Prod. no. 43118, Alfa Aesar by Thermo Fisher Scientific, Ward Hill, Mass., USA).

The AMBERLITE® XAD polymeric resins are nonpolar resins which are generally used for adsorption of organic substances from aqueous systems and polar solvents. The binding capacity of a resin for a particular material is affected by the dipole moment, the pore size and the surface area. Most AMBERLITE® XAD resins are nonpolar and may be used over a pH range of 0-14 a with maximum usage temperature 480° F. The AMBERLITE® XAD-7 is the only “moderately polar” XAD resin now available. It has been used to remove relatively polar compounds from non-aqueous solvents. For relatively low molecular weight (MW), AMBERLITE® XAD-4 is currently suggested. Synthetic adsorbents can tolerate caustic sanitization that cannot be applied to alkyl-bonded silica gels.

The physicochemical characteristics of these sorbents are summarized in Table 7.

TABLE 7

| | | | Surface | Pore |
|---|---|---|---|---|
| | | | area | radius |
| Resin | Chemical nature | Polarity | (m²/g) | (A) |
| AMBERLITE ® XAD-7HP | acrylic ester (dipole | moderately | 450 | 90 |
| | moment 1.8) | polar | | |
| DIAION ® HP 2MGL | methacrylate ester- | | 470 | 170 |
| | based polymeric resin | | | |
| SEPABEADS ® SP 70 | chemically modified | nonpolar | 800 | 70 |
| | polystyrene-DVB | | | |
| SEPABEADS ® SP700 | polystyrene-DVB | nonpolar | 1200 | 90 |
| AMBERLITE ® FPX 66 | styrene-DVB | nonpolar | 700 | 250 |
| FLORISIL ® | activated magnesium | nonpolar | 289 | |
| | silicate | | | |
| ZEOPREP ® 60-C18 | irregular Silica gel | nonpolar | 500 | 60 |
| Activated carbon | highly porous | nonpolar | 500-1500 | −4 + 8 |
| | carbonaceous material | | | mesh |

The adsorption of phenolic compounds from green tea PLP extracts onto and from the sorbents listed in Table 7, were assessed as outlined in Examples 4-8.

### Example 4: Effects of Flow Rate on PLP-Water Desorption of Phenolic Compounds from a Selected Sorbent

The objective of this study was to assess the efficiency of desorption of phenolic compounds bound to a selected sorbent using PLP water as the eluent solvent.

An extract comprising a mixture of phenolic compounds was solubilized and extracted from green tea leaf biomass using PLP water flowed through a PLP reaction vessel. Testing of the green tea PLP extract indicated that its total phenolic content was about 25 mg/mL.

AMBERLITE® FPX-66 resin beads were thoroughly wetted following the manufacturer's instructions. 40 g of wetted resin beads were placed into a 250-mL Erlenmeyer flask, then 50 mL of the green tea extract were added to the wetted resin beads, after which, the Erlenmeyer flask was sealed. The resin beads and extract were mixed at 160 rpm for 1 h on an orbital shaker to load the resin beads with compounds from the green tea extract. The loaded resin beads were separated from the extract supernatant, and then washed twice with 30 mL of deionized water. The loaded resin beads were then transferred into and packed within a stainless steel pressure-resistant column (20 cm long×2.2 cm ID) with frits in both ends.

The desorption process was started by setting the packed column into the PLPW system described in Example 1. Water was then pumped through the column at a 4 BV/h flow rate to bring the pressure up to about 200 psi. After the selected pressure was reached, the pump was turned off and the oven warmed up to a selected temperature of 130° C. for the desorption process. After the selected temperature was reached, the column was statically warmed for 15 min after which, the pump was restarted and desorption commenced at a PLP water flow rate of 2 BV/h. Sample collection commenced at 5 min after desorption commenced, and then at 10, 15, 20, 25, 30, 40, 50, 60, 70, 85, 95, 110, 125, and 140 min.

The desorption process was repeated with a fresh batch of extract-loaded and washed AMBERLITE® FPX-66 resin beads using a PLP water flow rate of 3 BV/h, and then repeated again with a fresh batch of extract-loaded and washed AMBERLITE® FPX-66 resin beads using a PLP water flow rate of 4 BV/h.

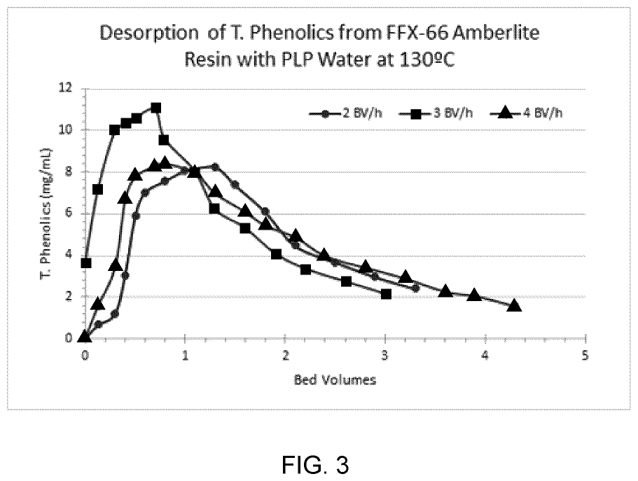

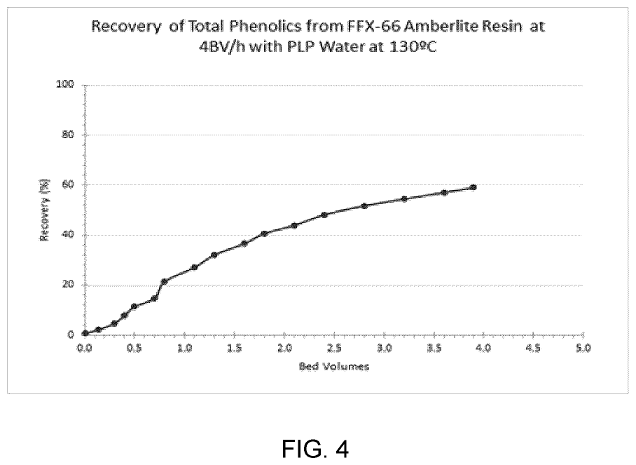

The data in FIG. 3 show that similar amounts of total phenolics eluates were collected at the same desorption time intervals with the 3 BV/h and 4 BV/h flow rates. However, the 2 BV/h flow rate required a longer eluate collection time period but did not produce a better recovery than the other flow rates. The data in FIG. 4 show that a minimum collection volume of 4BV was required to extract most of the total phenolics that were bound to the AMBERLITE® FPX-66 resin beads.

### Example 5: Effects of Temperatures on PLP-Water Desorption of Phenolic Compounds from Selected Sorbents

The objective of this study was to assess the effects of different temperatures on PLP water desorption of phenolic compounds bound to selected sorbents.

### 5.1 PLP Extract Mixtures

A first extract comprising a mixture of phenolic compounds was solubilized and extracted from green tea leaf biomass using PLP water flowed through a PLP reaction vessel. A second extract comprising a mixture of phenolic compounds was solubilized and extracted from elderberry biomass using PLP water flowed through a PLP reaction vessel. The two extracts were then mixed together to produce a complex mixture of phenolic compounds. Testing of the complex green tea/elderberry PLP extract mixture indicated that its total phenolic content was about 12 mg/mL.

5.2 Preparation and Loading of Sorbents with Compounds from Complex Extract Mixtures

The following sorbents were tested in this example: (i) AMBERLITE® FPX-66, (ii) AMBERLITE® XAD 7, (iii) FLORISIL®, (iv) ZEOPREP® 60-C18, and (v) SEPABEADS® SP70. Each of the sorbents was tested at three PLP water desorption temperatures i.e., 90° C., 130° C., and 180° C. Each of the resins was first washed, after which, the phenolic compounds in the complex green tea/elderberry PLP extract mixture were bound to the resin beads following the same process used in Example 1, whereby 40 g of wetted resin beads were placed into a 250-mL Erlenmeyer flask, then 50 mL of the green tea extract were added to the wetted resin beads, after which, the Erlenmeyer flask was sealed. The resin beads and extract mixture were mixed at 160 rpm for 1 h on an orbital shaker to load the resin beads with compounds from the green tea extract. The loaded resin beads were separated from the extract supernatant, and then washed twice with 30 mL of deionized water. The loaded resin beads were then transferred into and packed within a stainless steel pressure-resistant column (20 cm long×2.2 cm ID) with frits in both ends.

### 5.3 PLP Water Desorption of Loaded AMBERLITE® FPX-66 Resin

Washed AMBERLITE® FPX-66 resin loaded with bound phenolic compounds from the complex green tea/elderberry PLP extract mixture prepared as disclosed in sections 5.1 and 5.2, were transferred into and packed within a stainless steel pressure-resistant column (20 cm long×2.2 cm ID) with frits in both ends. The desorption process was started by setting the packed column into the PLPW system described in Example 1. Water was then pumped through the column at a 4 BV/h flow rate to bring the pressure up to about 200 psi. After the selected pressure was reached, the pump was turned off and the oven warmed up to a first selected temperature of 90° C. for the desorption process. After the selected temperature was reached, the column was statically warmed for 15 min after which, the pump was restarted and desorption commenced at a PLP water flow rate of 4 BV/h for a selected period of 1 h during which time, a first eluate sample was collected commencing 5 min after the PLP water flow was started until completion of the selected time period. The total sample volume collected was 4 BV.

A fresh batch of washed AMBERLITE® FPX-66 resin loaded with bound phenolic compounds from the complex green tea/elderberry PLP extract mixture prepared as disclosed in sections 5.1 and 5.2, were transferred into and packed within a stainless steel pressure-resistant column (20 cm long×2.2 cm ID) with frits in both ends that was then installed into the PLPW system. Water was then pumped through the column at a 4 BV/h flow rate to bring the pressure up to about 200 psi. After the selected pressure was reached, the pump was turned off and the oven warmed up to a second selected temperature of 130° C. for the desorption process. After the selected temperature was reached, the column was statically warmed for 15 min after which, the pump was restarted and desorption commenced at a PLP water flow rate of 4 BV/h for a selected period of 1 h during which time, a second eluate sample was collected commencing 5 min after the PLP water flow was started until completion of the selected time period. The total sample volume collected was 4 BV.

A fresh batch of washed AMBERLITE® FPX-66 resin loaded with bound phenolic compounds from the complex green tea/elderberry PLP extract mixture prepared as disclosed in sections 5.1 and 5.2, were transferred into and packed within a stainless steel pressure-resistant column (20 cm long×2.2 cm ID) with frits in both ends that was then installed into the PLPW system. Water was then pumped through the column at a 4 BV/h flow rate to bring the pressure up to about 200 psi. After the selected pressure was reached, the pump was turned off and the oven warmed up to a third selected temperature of 180° C. for the desorption process. After the selected temperature was reached, the column was statically warmed for 15 min after which, the pump was restarted and desorption commenced at a PLP water flow rate of 4 BV/h for a selected period of 1 h during which time, a third eluate sample was collected commencing 5 min after the PLP water flow was started until completion of the selected time period. The total sample volume collected was 4 BV.

The three eluate samples were then analyzed for their content of (i) caffeine, (ii) catechins, (iii) flavonols, and (iv) total phenols. The analyses were carried out using an AGILENT® HP 1100 series HPLC (AGILENT is a registered trademark of Agilent Technologies Inc., Santa Clara, Calif., USA). The chromatographic separations were carried out on a KINETIX® RP C-18 column (2.6u, 100 Å, 150×3 mm); Phenomenex, Torrance, Calif.), and with a PHENOMENEX® Ultra guard column (C-18, 3 mm) (KINETIX AND PHENOMENEX are registered trademarks of Phenomenex Inc., Torrance, Calif., USA). HPLC analysis of 10-μL samples of the three eluate samples were analyzed by RP-HPLC coupled with a photodiode array detector and signal at a temperature of 30° C., a flow rate of 0.5 mL/min, and absorbance measured at 280 nm, 320 nm, 360 nm, and 520 nm. Run times were 60 min with a post time of 2 min.

Caffeine and catechins were determined as EGCG equivalents of added peak areas of epigallocatechin (EGC), catechin, epicatechin, epigallocatechin gallate (EGCG), epicatechin gallate (E3G), and unknown peak at retention time (21 min) after EGCG time, cyanidin 3-sambubioside, and flavonols as rutin equivalents of added peak areas of major six flavonols. Contents were estimated by identifying the markers by comparison with standard peaks of retention times, and UV spectra. Marker contents were determined by standard curves of caffeine, EGCG, cyanidin-3-glucoside and rutin. Solvent A was 0.5% phosphoric acid in HPLC-grade water; Solvent B was HPLC-grade 100% acetonitrile.

Solvent gradient:

| Time (min) | A (%) |
|---|---|
| 0 | 93 |
| 2 | 93 |
| 7 | 89 |
| 20 | 89 |
| 30 | 83 |
| 54 | 73 |
| 56 | 5 |
| 58 | 5 |
| 60 | 93 |

The adsorption ratio (E) was calculated as a percentage of the total amount of the marker present in the initial extract.

E=(Cₒ−Cₑ)Co 100 (1)

where E was the adsorption ratio (percentage); Cₒ and Cₑ were initial and equilibrium concentrations (mg/L) of solute in the solution, respectively.

Desorption ratio was evaluated as a percentage of the amount adsorbed into the adsorbent,

D=(C_{d}V_{d})(Cₒ−Cₑ)Vo100 (2)

where D was the desorption ratio (percentage), C_{d} was the concentration of the solute in the desorption solution (mg/L), V_{d} was the volume of the desorption solution (mL), and Vₒ was the volume of the initial solution (mL).

Recovery (R) of the markers after purification was evaluated as a percentage of the total amount of the marker in the initial solution.

R=C_{d}vdCₒvo100 (3)

where R was the recovery (percentage), C_{d}, Cₒ, and V_{d}, Vₒ were the same as described before.

The data in Table 8 show that there was an excellent adsorption ratio of the phenolic compounds from the complex green tea/elderberry PLP extract mixture onto AMBERLITE® FPX-66 resin, and that PLP water eluent provided very good desorption ratios of the bound compounds from the AMBERLITE® FPX-66 resin loaded with bound phenolic compounds from the complex green tea/elderberry PLP extract mixture. At the 180° C., the recoveries of total phenolics and caffeine were as high as 77%, and the recovery of catechins recovery was about 62%.

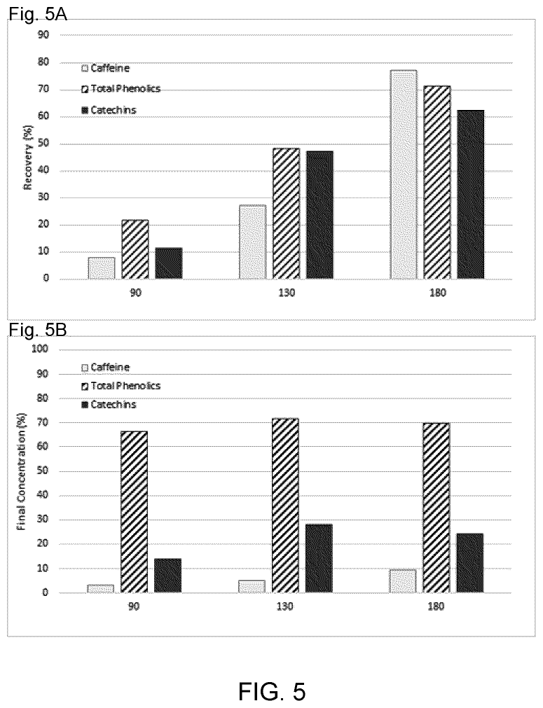

The data in FIG. 5A show the recovery of caffeine, catechins, and total phenolics from AMBERLITE® FPX-66 resin with PLP water eluant at 90° C., 130° C., and 180° C. The data in FIG. 5B show the final concentration of caffeine, catechins, and total phenolics in eluates discharged from loaded AMBERLITE® FPX-66 resin with PLP water eluant at 90° C., 130° C., and 180° C.

TABLE 8
Adsorption and desorption of caffeine, catechins, flavonols, and total
phenolics onto and from AMBERLITE ® FPX-66 resin with PLP water eluant

| | | | Adsorption | Desorption | | Concentration | | |
|---|---|---|---|---|---|---|---|---|
| | Temp | Marker | Ratio | Ratio | Recovery | (% w/w) | | Residue |
| | (° C.) | group | (%) | (%) | (%) | Initial | Final | (% w/w) |
| FPX-66 | 90 | Caffeine | 99.27 | 8.06 | 8.00 | 5.38 | 3.00 | 0.56 |
| | 130 | | 99.17 | 27.38 | 27.15 | 5.39 | 4.98 | 0.33 |
| | 180 | | 99.39 | 77.52 | 77.04 | 5.36 | 9.23 | 0.01 |
| FPX-66 | 90 | Catechins | 99.27 | 11.54 | 11.46 | 17.42 | 13.91 | 1.88 |
| | 130 | | 99.27 | 47.7 | 47.35 | 17.48 | 28.16 | 0.66 |
| | 180 | | 99.29 | 63.02 | 62.57 | 17.37 | 24.31 | 0.02 |
| FPX-66 | 90 | Flavonols | 100 | 0 | 0 | 1.74 | 0 | 0.22 |
| | 130 | | 100 | 4.88 | 4.88 | 1.75 | 0.29 | 0.2 |
| | 180 | | 100 | 43.01 | 43.01 | 1.74 | 1.67 | 0.05 |
| FPX-66 | 90 | Total | 96.4 | 23.84 | 22.98 | 43.07 | 68.95 | 3.08 |
| | 130 | Phenolics | 95.87 | 55.64 | 53.34 | 43.21 | 78.41 | 1.32 |
| | 180 | | 95.9 | 77.39 | 74.22 | 42.93 | 71.26 | 0.16 |

### 5.4 PLP Water Desorption of Loaded AMBERLITE® XAD 7HP Resin

Washed AMBERLITE® XAD 7HP resin beads loaded with bound phenolic compounds from the complex green tea/elderberry PLP extract mixture prepared as disclosed in sections 5.1 and 5.2, were transferred into and packed within a stainless steel pressure-resistant column (20 cm long×2.2 cm ID) with frits in both ends. The desorption process was started by setting the packed column into the PLPW system described in Example 1. Water was then pumped through the column at a 4 BV/h flow rate to bring the pressure up to about 200 psi. After the selected pressure was reached, the pump was turned off and the oven warmed up to a first selected temperature of 90° C. for the desorption process. After the selected temperature was reached, the column was statically warmed for 15 min after which, the pump was restarted and desorption commenced at a PLP water flow rate of 4 BV/h for a selected period of 1 h during which time, a first eluate sample was collected commencing 5 min after the PLP water flow was started until completion of the selected time period. The total sample volume collected was 4 BV. This process was repeated with a second stainless steel pressure-resistant column packed with fresh loaded AMBERLITE® XAD 7HP resin beads with a second selected temperature of 130° C. for the desorption process thereby producing a second eluate sample. This process was repeated with a third stainless steel pressure-resistant column packed with fresh loaded AMBERLITE® XAD 7HP resin beads with a second selected temperature of 180° C. for the desorption process thereby producing a third eluate sample.

The data in Table 9 show that there were excellent adsorption ratios and desorption ratios for all four marker compounds from the complex green tea/elderberry PLP extract mixture i.e., caffeine, catechins, flavonols, and total phenolics onto and from the AMBERLITE® XAD 7HP resin. Very high recoveries of total phenolics and caffeine were achieved at 130° C. and 180° C. Also the final concentration of caffeine at in the range of 90° C. to 130° C. was higher than the initial concentration, so it is possible to concentrate the above mentioned markers with the XAD 7HP adsorbent. The adsorbent can also be used for fractionation of extracts with a final fraction more concentrated in caffeine, and others more concentrated in catechins and flavonols.

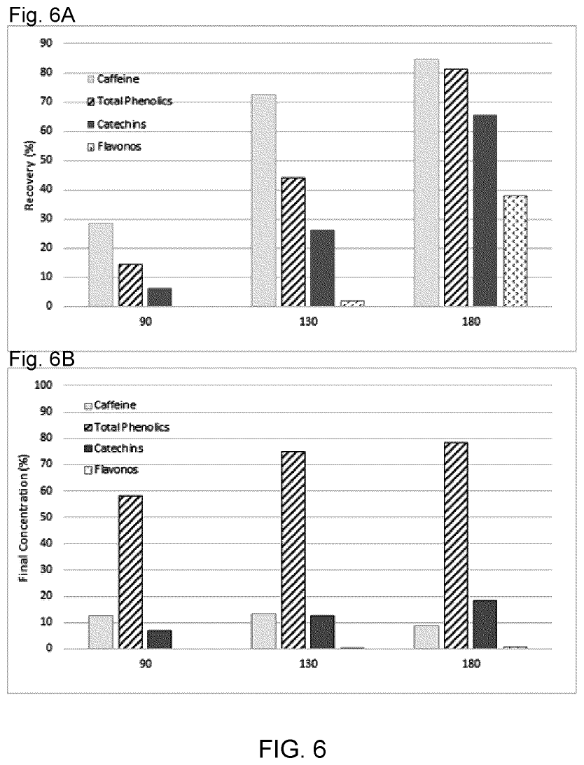

The data in FIG. 6A show the recovery of caffeine, catechins, and total phenolics from AMBERLITE® XAD 7HP resin with PLP water eluant at 90° C., 130° C., and 180° C. The data in FIG. 6B show the final concentration of caffeine, catechins, and total phenolics in eluates discharged from loaded AMBERLITE® XAD 7HP resin with PLP water eluant at 90° C., 130° C., and 180° C.

TABLE 9
Adsorption and desorption of caffeine, catechins, flavonols, and total
phenolics onto and from AMBERLITE ® XAD 7HP resin with PLP water eluant

| | | | Adsorption | Desorption | | Concentration | | |
|---|---|---|---|---|---|---|---|---|
| | Temp | Marker | Ratio | Ratio | Recovery | (% w/w) | | Residue |
| | (° C.) | group | (%) | (%) | (%) | Initial | Final | (% w/w) |
| XAD 7HP | 90 | Caffeine | 93.58 | 30.47 | 28.51 | 5.1 | 12.46 | 0.19 |
| | 130 | | 94.28 | 76.94 | 72.54 | 5.13 | 13.39 | 0.01 |
| | 180 | | 93.68 | 90.31 | 84.6 | 5.15 | 8.84 | 0 |
| XAD 7HP | 90 | Catechins | 98.81 | 6.09 | 6.01 | 13.55 | 6.98 | 1.23 |
| | 130 | | 98.82 | 26.35 | 26.04 | 13.62 | 12.76 | 0.78 |
| | 180 | | 98.77 | 66.28 | 65.47 | 13.69 | 18.16 | 0.02 |
| XAD 7HP | 90 | Flavonols | 100 | 0 | 0 | 0.76 | 0 | 0.071 |
| | 130 | | 100 | 1.87 | 1.87 | 0.76 | 0.05 | 0.053 |
| | 180 | | 100 | 37.83 | 37.83 | 0.76 | 0.59 | ND |
| XAD 7HP | 90 | Total | 95.97 | 15.04 | 14.44 | 47.14 | 58.3 | 3.4 |
| | 130 | Phenolics | 96.13 | 45.77 | 43.99 | 47.37 | 75.01 | 2.09 |
| | 180 | | 95.99 | 84.48 | 81.09 | 47.63 | 78.27 | 0.26 |

### 5.5 PLP Water Desorption of Loaded SEPABEADS® SP 70 Sorbent

Washed SEPABEADS® SP 70 sorbent loaded with bound phenolic compounds from the complex green tea/elderberry PLP extract mixture prepared as disclosed in sections 5.1 and 5.2, were transferred into and packed within a stainless steel pressure-resistant column (20 cm long×2.2 cm ID) with frits in both ends. The desorption process was started by setting the packed column into the PLPW system described in Example 1. Water was then pumped through the column at a 4 BV/h flow rate to bring the pressure up to about 200 psi. After the selected pressure was reached, the pump was turned off and the oven warmed up to a first selected temperature of 90° C. for the desorption process. After the selected temperature was reached, the column was statically warmed for 15 min after which, the pump was restarted and desorption commenced at a PLP water flow rate of 4 BV/h for a selected period of 1 h during which time, a first eluate sample was collected commencing 5 min after the PLP water flow was started until completion of the selected time period. The total sample volume collected was 4 BV. This process was repeated with a second stainless steel pressure-resistant column packed with fresh loaded SEPABEADS® SP 70 sorbent with a second selected temperature of 130° C. for the desorption process thereby producing a second eluate sample. This process was repeated with a third stainless steel pressure-resistant column packed with fresh loaded SEPABEADS® SP 70 sorbent with a second selected temperature of 180° C. for the desorption process thereby producing a third eluate sample.

The data in Table 10 show that there were excellent adsorption ratios for all four marker compounds from the complex green tea/elderberry PLP extract mixture i.e., caffeine, catechins, flavonols, and total phenolics onto the SEPABEADS® SP 70 sorbent. Very high recoveries of caffeine and total phenolics were achieved at 180° C. However, the PLP water eluent did not desorb any catechins from the SEPABEADS® SP 70 sorbent.

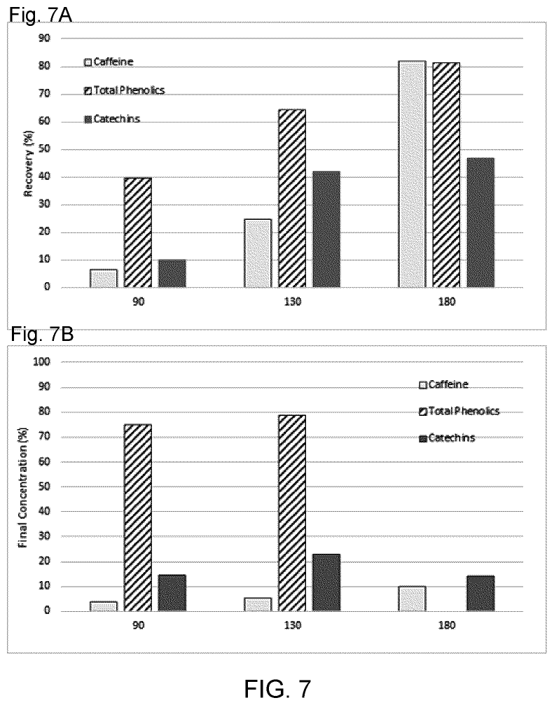

The data in FIG. 7A show the recovery of caffeine, catechins, and total phenolics from SEPABEADS® SP 70 sorbent with PLP water eluant at 90° C., 130° C., and 180° C. The data in FIG. 7B show the final concentration of caffeine, catechins, and total phenolics in eluates discharged from loaded SEPABEADS® SP 70 sorbent with PLP water eluant at 90° C., 130° C., and 180° C.

TABLE 10
Adsorption and desorption of caffeine, catechins, flavonols, and total
phenolics onto and from SEPABEADS ® SP 70 sorbent with PLP water eluant

| | | | Adsorption | Desorption | | Concentration | | |
|---|---|---|---|---|---|---|---|---|
| | Temp | Marker | Ratio | Ratio | Recovery | (% w/w) | | Residue |
| | (° C.) | group | (%) | (%) | (%) | Initial | Final | (% w/w) |
| SP 70 | 90 | Caffeine | 99.56 | 6.57 | 6.54 | 5.1 | 3.8 | 0.42 |
| | 130 | | 99.67 | 24.69 | 24.6 | 5.1 | 5.3 | 0.26 |
| | 180 | | 99.56 | 82.25 | 81.89 | 5.0 | 9.9 | 0.03 |
| SP 70 | 90 | Catechins | 98.77 | 10 | 9.87 | 12.74 | 14.39 | 0.89 |
| | 130 | | 98.76 | 42.39 | 41.86 | 12.74 | 22.73 | 0.31 |
| | 180 | | 98.69 | 47.45 | 46.83 | 12.69 | 14.28 | 0.02 |
| SP 70 | 90 | Flavonols | 100 | 0 | 0 | 0.66 | 0 | 0.64 |
| | 130 | | 100 | 0 | 0 | 0.66 | 0 | 0.47 |
| | 180 | | 100 | 19.4 | 19.4 | 0.66 | 0.31 | 0.0 |
| SP 70 | 90 | Total | 94.92 | 41.57 | 39.46 | 52.67 | 74.88 | 0.95 |
| | 130 | Phenolics | 95.13 | 67.56 | 64.27 | 52.18 | 78.75 | 0.73 |
| | 180 | | 94.7 | 85.79 | 81.25 | 52.58 | | 0.3 |

### 5.6 PLP Water Desorption of Loaded FLORISIL® Sorbent

Washed FLORISIL® sorbent loaded with bound phenolic compounds from the complex green tea/elderberry PLP extract mixture prepared as disclosed in sections 5.1 and 5.2, were transferred into and packed within a stainless steel pressure-resistant column (20 cm long×2.2 cm ID) with frits in both ends. The desorption process was started by setting the packed column into the PLPW system described in Example 1. Water was then pumped through the column at a 4 BV/h flow rate to bring the pressure up to about 200 psi. After the selected pressure was reached, the pump was turned off and the oven warmed up to a first selected temperature of 90° C. for the desorption process. After the selected temperature was reached, the column was statically warmed for 15 min after which, the pump was restarted and desorption commenced at a PLP water flow rate of 4 BV/h for a selected period of 1 h during which time, a first eluate sample was collected commencing 5 min after the PLP water flow was started until completion of the selected time period. The total sample volume collected was 4 BV. This process was repeated with a second stainless steel pressure-resistant column packed with fresh loaded FLORISIL® sorbent with a second selected temperature of 130° C. for the desorption process thereby producing a second eluate sample. This process was repeated with a third stainless steel pressure-resistant column packed with fresh loaded FLORISIL® sorbent with a second selected temperature of 180° C. for the desorption process thereby producing a third eluate sample.

The data in Table 11 show that there were excellent adsorption ratios for all four marker compounds from the complex green tea/elderberry PLP extract mixture i.e., caffeine, catechins, flavonols, and total phenolics onto the FLORISIL® sorbent. However, the recoveries of the four marker compounds from the FLORISIL® sorbent were moderate at 130° C. and 180° C.

TABLE 11
Adsorption and desorption of caffeine, catechins, flavonols, and total phenolics
onto and from FLORISIL ® sorbent with PLP water eluant

| | | | Adsorption | Desorption | | Concentration | | |
|---|---|---|---|---|---|---|---|---|
| | temp | marker | Ratio | Ratio | Recovery | (% w/w) | | Residue |
| | (° C.) | group | (%) | (%) | (%) | Initial | Final | (% w/w) |
| Florisil | 90 | Caffeine | 98.83 | 9.74 | 9.63 | 5.34 | 1.59 | 0.18 |
| | 130 | | 99.01 | 27.91 | 27.63 | 5.42 | 3.51 | 0.1 |
| | 180 | | 98.9 | 72.16 | 71.37 | 5.38 | 7.74 | 0.01 |
| Florisil | 90 | Catechins | 98.23 | 5.6 | 5.5 | 17.31 | 2.94 | 0.02 |
| | 130 | | 98.59 | 4.43 | 4.37 | 17.56 | 1.8 | 0.01 |
| | 180 | | 98.85 | 3.48 | 3.44 | 17.44 | 1.21 | 0.01 |
| Florisil | 90 | Flavonols | 81.21 | 10.6 | 8.6 | 1.73 | 0.46 | 0 |
| | 130 | | 79.04 | 18.33 | 14.49 | 1.76 | 0.6 | 0 |
| | 180 | | 78.84 | 14.8 | 11.67 | 1.74 | 0.41 | ND |
| Florisil | 90 | Total | 82.08 | 30.98 | 25.43 | 42.79 | 33.62 | 0.04 |
| | 130 | Phenolics | 81.36 | 35.13 | 28.58 | 43.4 | 29.06 | 0.04 |
| | 180 | | 82.13 | 30.7 | 25.21 | 43.1 | 21.91 | 0.03 |

### 5.7 PLP Water Desorption of Loaded ZEOPREP° C.18 Sorbent

Washed ZEOPREP® C18 sorbent loaded with bound phenolic compounds from the complex green tea/elderberry PLP extract mixture prepared as disclosed in sections 5.1 and 5.2, were transferred into and packed within a stainless steel pressure-resistant column (20 cm long×2.2 cm ID) with frits in both ends. The desorption process was started by setting the packed column into the PLPW system described in Example 1. Water was then pumped through the column at a 4 BV/h flow rate to bring the pressure up to about 200 psi. After the selected pressure was reached, the pump was turned off and the oven warmed up to a first selected temperature of 90° C. for the desorption process. After the selected temperature was reached, the column was statically warmed for 15 min after which, the pump was restarted and desorption commenced at a PLP water flow rate of 4 BV/h for a selected period of 1 h during which time, a first eluate sample was collected commencing 5 min after the PLP water flow was started until completion of the selected time period. The total sample volume collected was 4 BV. This process was repeated with a second stainless steel pressure-resistant column packed with fresh loaded ZEOPREP® C18 sorbent with a second selected temperature of 130° C. for the desorption process thereby producing a second eluate sample.

The data in Table 12 show that there were excellent adsorption ratios for all four marker compounds from the complex green tea/elderberry PLP extract mixture i.e., caffeine, catechins, flavonols, and total phenolics onto the ZEOPREP® C18 sorbent. Very good recoveries of caffeine and catechins were achieved at 90° C. and 130° C. The recoveries of flavonols and total phenolics from the ZEOPREP® C18 sorbent were moderate at both temperatures.

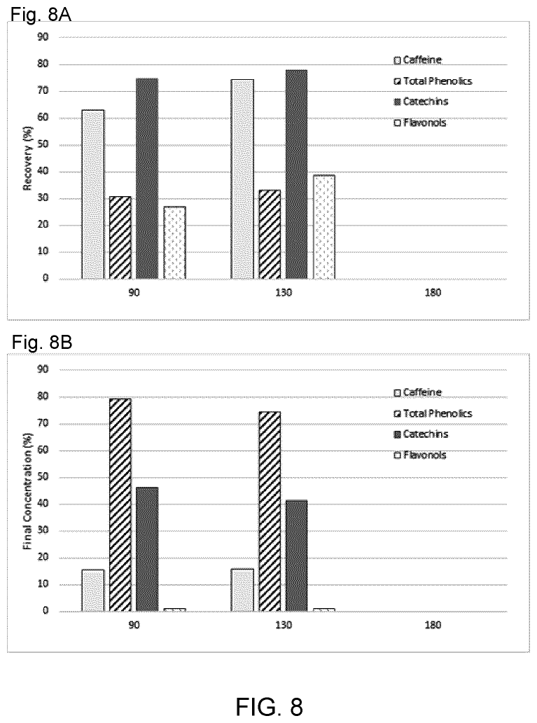

The data in FIG. 8A show the recovery of caffeine, catechins, and total phenolics from ZEOPREP® C18 sorbent with PLP water eluant at 90° C. and 130° C. The data in FIG. 8B show the final concentration of caffeine, catechins, and total phenolics in eluates discharged from loaded ZEOPREP® C18 sorbent with PLP water eluant at 90° C. and 130° C.

TABLE 12
Adsorption and desorption of caffeine, catechins, flavonols, and total phenolics
onto and from ZEOPREP ® C18 sorbent with PLP water eluant

| | | | Adsorption | Desorption | | Concentration | | |
|---|---|---|---|---|---|---|---|---|
| | Temp | Marker | Ratio | Ratio | Recovery | (% w/w) | | Residue |
| | (° C.) | group | (%) | (%) | (%) | Initial | Final | (% w/w) |
| Zeolite | 90 | Caffeine | 94.23 | 66.79 | 62.94 | 5.03 | 15.51 | 0.00 |
| C18 | 130 | | 93.78 | 79.40 | 74.46 | 5.0 | 15.7 | 0.00 |
| Zeolite | 90 | Catechins | 88.74 | 83.97 | 74.52 | 12.66 | 46.19 | 0.08 |
| C18 | 130 | | 82.81 | 93.93 | 77.77 | 12.56 | 41.23 | 0.06 |
| Zeolite | 90 | Flavonols | 100 | 26.68 | 26.68 | 0.65 | 0.85 | 0.12 |
| C18 | 130 | | 100 | 38.54 | 38.54 | 0.65 | 1.05 | 0.07 |
| Zeolite | 90 | Total | 82.04 | 37.37 | 30.66 | 52.85 | 79.30 | 0.41 |
| C18 | 130 | Phenolics | 80.92 | 40.64 | 32.89 | 53.48 | 74.23 | 0.40 |

### 5.8 PLP Water Desorption of Loaded Activated Carbon Sorbent

Washed activated carbon sorbent loaded with bound phenolic compounds from the complex green tea/elderberry PLP extract mixture prepared as disclosed in sections 5.1 and 5.2, were transferred into and packed within a stainless steel pressure-resistant column (20 cm long×2.2 cm ID) with frits in both ends. The desorption process was started by setting the packed column into the PLPW system described in Example 1. Water was then pumped through the column at a 4 BV/h flow rate to bring the pressure up to about 200 psi. After the selected pressure was reached, the pump was turned off and the oven warmed up to a first selected temperature of 90° C. for the desorption process. After the selected temperature was reached, the column was statically warmed for 15 min after which, the pump was restarted and desorption commenced at a PLP water flow rate of 4 BV/h for a selected period of 1 h during which time, a first eluate sample was collected commencing 5 min after the PLP water flow was started until completion of the selected time period. The total sample volume collected was 4 BV. This process was repeated with a second stainless steel pressure-resistant column packed with fresh loaded activated carbon sorbent with a second selected temperature of 130° C. for the desorption process thereby producing a second eluate sample.

The data in Table 13 show that there were excellent adsorption ratios for all four marker compounds from the complex green tea/elderberry PLP extract mixture i.e., caffeine, catechins, flavonols, and total phenolics onto the activated carbon sorbent. Very good recoveries of caffeine and catechins were achieved at 90° C. and 130° C. The recoveries of flavonols and total phenolics from the activated carbon sorbent were moderate at both temperatures.

TABLE 13
Adsorption and desorption of caffeine, catechins, flavonols, and total
phenolics onto and from activated carbon sorbent with PLP water eluant

| | | | Adsorption | Desorption | | Concentration | | |
|---|---|---|---|---|---|---|---|---|
| | Temp | Marker | Ratio | Ratio | Recovery | (% w/w) | | Residue |
| | (° C.) | group | (%) | (%) | (%) | Initial | Final | (%) |
| Activated | 90 | Caffeine | 96.88 | 0.35 | 0.34 | 3.63 | 0.11 | 0.02 |
| Carbon | 130 | | 97.14 | 0.50 | 0.49 | 3.63 | 0.1 | 0.00 |
| | 180 | | 97.01 | 0.89 | 0.87 | 3.63 | 0.12 | 0.01 |
| Activated | 90 | Catechins | 92.65 | 8.66 | 8.02 | 4.06 | 0.21 | 0.00 |
| Carbon | 130 | | 92.45 | 7.46 | 6.9 | 4.06 | 0.19 | 0.00 |
| | 180 | | 92.55 | 7.18 | 6.65 | 4.06 | 0.22 | 0.00 |
| Activated | 90 | Flavonols | 51.04 | 0.0 | 0.0 | 0.35 | 0 | 0.00 |
| Carbon | 130 | | 50.64 | 0.0 | 0.0 | 0.35 | 0 | 0.00 |
| | 180 | | 50.84 | 0.0 | 0.0 | 0.35 | 0 | 0.00 |
| Activated | 90 | Total | 43.29 | 39.40 | 17.06 | 39.87 | 47.27 | |
| Carbon | 130 | Phenolics | 44.61 | 30.91 | 13.79 | 39.87 | 32.58 | |
| | 180 | | 42.38 | 28.75 | 12.19 | 39.87 | 39.7 | |

### Example 6: Comparison of PLP-Water Desorption and Concentration of Caffeine from Selected Sorbents

The objective of this study was to compare the efficiencies of PLP water desorption of caffeine from bound to selected sorbents.

An extract comprising a mixture of phenolic compounds was solubilized and extracted from green tea leaf biomass using PLP water flowed through a PLP reaction vessel. Testing of the green tea PLP extract indicated that its total phenolic content was about 25 mg/mL.

The following sorbents were assessed in this study:
AMBERLITE® FPX-66
AMBERLITE® XAD 7HP
SEPABEADS® SP 70
FLORISIL®
ZEOPREP° C.18

Each sorbent was washed and loaded with the compounds from the green tea PLP extract, and then packed into a stainless steel pressure-resistant column (20 cm long×2.2 cm ID) with frits in both ends, as described in Example 5. Then, each column was pressurized and warmed to a selected temperature after which, caffeine was eluted from the loaded sorbent with PLP water eluent as described in Example 5. Each loaded sorbent was separately processed at 90° C., 130° C., and 180° C. as described in Example 5.

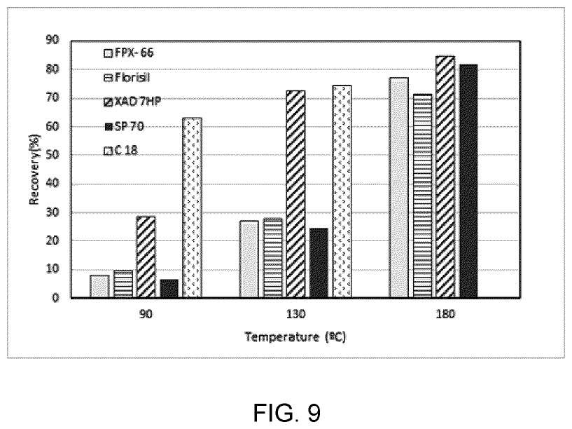

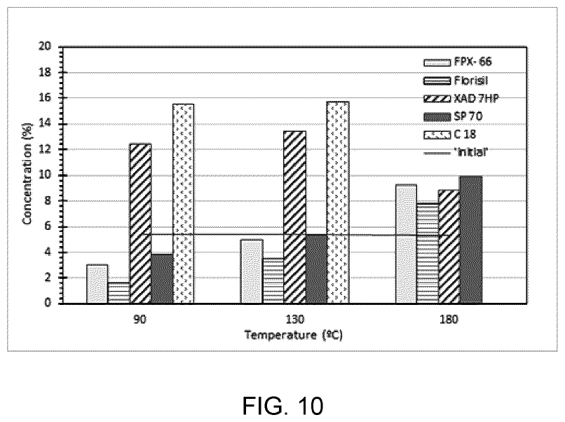

The recoveries of caffeine eluted from the different adsorbents by the PLP water eluent are shown in FIG. 9. The highest recoveries of caffeine occurred at 180° C. from the AMBERLITE® FPX-66 (over 75%), AMBERLITE® XAD 7HP (over 80%), SEPABEADS® SP 70 (over 80%), and FLORISIL® sorbents (over 70%). The recoveries of caffeine from the ZEOPREP® C18 sorbent were over 60% at 90° C. and over 70% at 130° C. However, no caffeine was recovered from the ZEOPREP® C18 sorbent at 180° C. The data in FIG. 10 show the initial concentration of caffeine in the PLP extract solution that was loaded onto the sorbents prior to elution with PLP water (the horizontal line extending across the three sets of bars, and the final concentrations of caffeine in the eluates collected from each sorbent during elution at 90° C., 130° C., and 180° C. Concentrations of caffeine higher than 12% were achieved at 90° C. and 130° C. from AMBERLITE® XAD 7HP and from ZEOPREP® C18 (FIG. 10). Concentration of caffeine was increased more than 2.5 and 3 times by adsorption to and desorption from the AMBERLITE® XAD 7HP and from ZEOPREP® C18 sorbents, in reference to the initial concentration of caffeine that was loaded onto these sorbents (FIG. 10).

Accordingly, the data produced in this example and in Example 5 demonstrate that it is possible to fractionate a green tea extract adsorbed onto AMBERLITE® XAD 7HP sorbent, into a rich caffeine fraction (˜35%) desorbed at 90° C.-100° C. with a PLP water eluant, followed elution of a second fraction at about 160° C. having a higher catechins concentration as well as caffeine and flavonols. Similarly, these data indicate that it is possible to fractionate a green tea extract adsorbed onto AMBERLITE® FPX-66 sorbent, into a rich caffeine fraction (˜35%) desorbed at 120° C.-130° C. with a PLP water eluant, followed elution of a second fraction at about 180° C. having a higher catechins concentration as well as caffeine and flavonols.

### Example 7: Effects of Temperature on PLP-Water Desorption and Concentration of Caffeine from AMBERLITE® XAD 7HP

Washed AMBERLITE® XAD 7HP resin beads loaded with bound phenolic compounds from the complex green tea/elderberry PLP extract mixture prepared as disclosed in sections 5.1 and 5.2, were transferred into and packed within a stainless steel pressure-resistant column (20 cm long×2.2 cm ID) with frits in both ends. The desorption process was started by setting the packed column into the PLPW system described in Example 1. Water was then pumped through the column at a 4 BV/h flow rate to bring the pressure up to about 200 psi. After the selected pressure was reached, the pump was turned off and the oven warmed up to a first selected temperature of 75° C. for the desorption process. After the selected temperature was reached, the column was statically warmed for 15 min after which, the pump was restarted and desorption commenced at a PLP water flow rate of 4 BV/h for a selected period of 1 h during which time, a first eluate sample was collected commencing 5 min after the PLP water flow was started until completion of the 1 h time period. The total sample volume collected was 4 BV. The oven was then heated to the second selected temperature of 145° C. after which, the column was statically warmed for 15 min after which, the pump was restarted and desorption commenced at a PLP water flow rate of 4 BV/h for a selected period of 1 h during which time, a second eluate sample was collected commencing 5 min after the PLP water flow was started until completion of the 1 h time period. The total second sample volume collected was 4 BV.

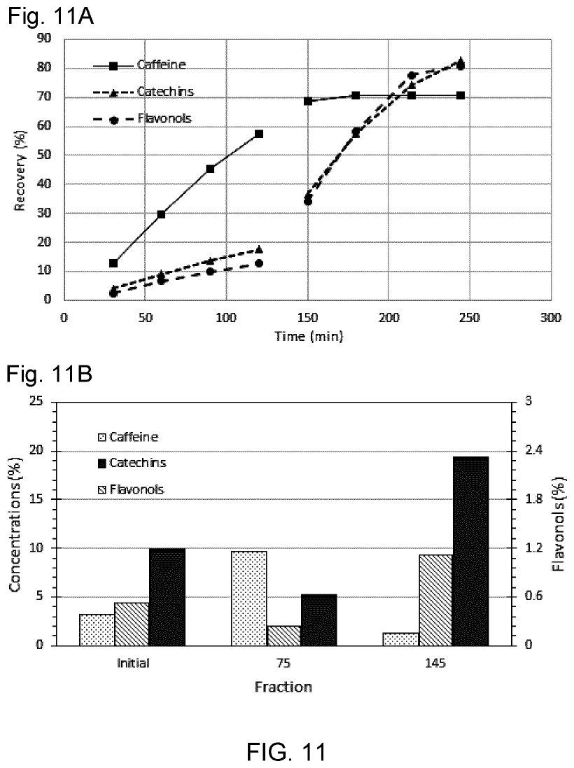

The data in FIG. 11A show the recovery of caffeine, catechins, and flavonols from AMBERLITE® XAD 7HP resin during the first extraction with PLP water eluant at 75° C., and during the second extraction with PLP water at 145° C. The data in FIG. 11B show the final concentration of caffeine, catechins, and flavonols in prior to loading onto the AMBERLITE® XAD 7HP resin, from the first eluate discharged with PLP water at 75° C., and from the second eluate discharged with PLP water at 145° C. A caffeine concentration of about 2.5-3.5 times the initial concentration was reached with recoveries of the marker of 58 to 62% in the first 75° C. eluant fraction. In the second 145° C. eluant fraction, recoveries of 65-70% of catechins and 58-68% of flavonols were observed along with 2-3-fold increases of concentrations of both markers

### Example 8: Effects of Temperature on PLP-Water Desorption and Concentration of Caffeine from Guarana Extract Loaded onto AMBERLITE® XAD 7HP

An extract comprising a mixture of phenolic compounds was solubilized and extracted from guarana whole beans using PLP water flowed through a PLP reaction vessel as disclosed in Example 5 sections 5.1 and 5.2. Testing of the green tea PLP extract indicated that its total phenolic content was about 19.9% (w/w).

The guarana extract was loaded onto washed AMBERLITE® XAD 7HP resin beads in a 1-inch as disclosed in Example 5 section 5.4, for about 2 h. The loaded resin beads were then transferred into and packed within a stainless steel pressure-resistant column (20 cm long×2.2 cm ID) with frits in both ends. The desorption process was started by setting the packed column into the PLPW system described in Example 1. Water was then pumped through the column at a 4 BV/h flow rate to bring the pressure up to about 200 psi. After the selected pressure was reached, the pump was turned off and the oven warmed up to a first selected temperature of 80° C. for the desorption process. After the selected temperature was reached, the column was statically warmed for 15 min after which, the pump was restarted and desorption commenced at a PLP water flow rate of 4 BV/h for a selected period of 1 h during which time, five 150-mL eluate samples were sequentially collected commencing 5 min after the PLP water flow was started until completion of the 1 h time period (total of 750 mL). Then, the temperature was increased to the second selected temperature of 180° and the column was statically warmed for 15 min after which, three 150-mL samples were collected (total of 450 mL).

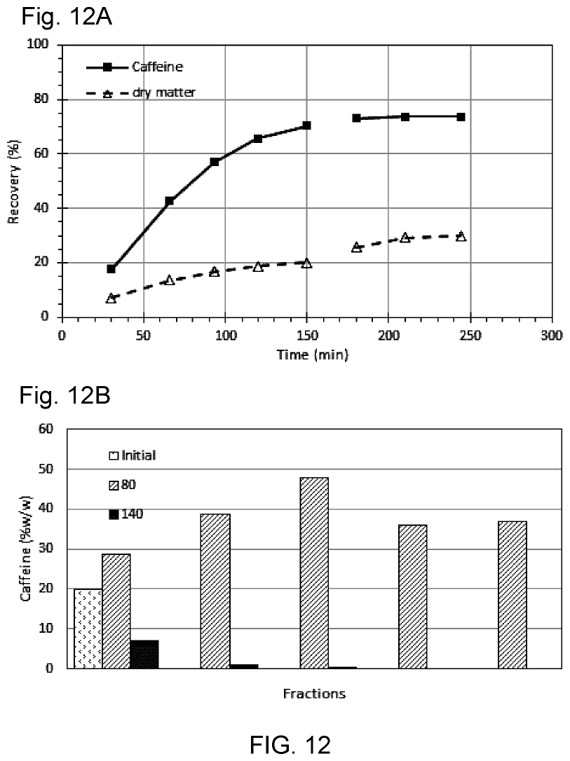

The caffeine concentrations in the guarana extract were determined with HPLC analyses following the procedure disclosed in above Example 5 section 5.3. The caffeine concentration in the guarana extract was 19.9% (w/w) prior to loading onto the AMBERLITE® XAD 7HP resin beads. The total recovery of caffeine from guarana extract from AMBERLITE® XAD 7HP in the 80° C. was about 70% (FIG. 12B). Only 3.25% of caffeine was recovered in the 140° C. fraction, indicating that almost all the recovered caffeine was collected in the 80° C. fractions (FIG. 12A). The total caffeine concentration in the five PLPW eluants collected at 80° C. was about 70%. At the high temperature only 3.25% of caffeine was obtained in the 140° C. fraction, indicating that almost all the recovered caffeine was collected in the 80° C. fractions (FIG. 12A). Furthermore, the data in FIG. 12B indicate that caffeine was concentrated up to approximately 36% in the combined 80° C. eluant fractions (FIG. 12B). The concentration of caffeine in the three eluant fractions collected at 140° C. was 4.3% (w/w) (FIG. 12B).

1. A method for separating and recovering components from a liquid feedstock, comprising the steps of:
packing a selected sorbent loaded with components from the liquid feedstock, into a first temperature-controlled pressure-resistant column;
sealably engaging the first temperature-controlled pressure-resistant column with (i) a supply of water, and (ii) a cooling equipment for receiving a flow of an eluate from the temperature-controlled pressure-resistant column;
from the supply of water, producing a first flow of pressurized low-polarity (PLP) water at a first selected temperature;
flowing the first flow of PLP water through the temperature-controlled pressure-resistant column thereby producing a first flow of the eluate therefrom, said eluate containing the one or more components;
cooling the first flow of the eluate; and collecting the cooled first flow of the eluate.

2. The method according claim 1, additionally comprising a step of commingling the liquid feedstock with the selected sorbent whereby one or more components in the liquid feedstock are bound onto the sorbent, thereby producing a loaded sorbent.

3. The method according claim 1, additionally comprising:
producing a second flow of PLP water at a second selected temperature; flowing the second flow of PLP water through the first temperature-controlled pressure-resistant column thereby producing a second flow of the eluate therefrom, said eluate containing the one or more components;
cooling the second flow of the eluate; and collecting the cooled second flow of the eluate.

4. A method according claim 3, additionally comprising:
producing a third flow of PLP water at a third selected temperature;
flowing the third flow of PLP water through the first temperature-controlled pressure-resistant column thereby producing a third flow of the eluate therefrom, said eluate containing the one or more components;
cooling the third flow of the eluate; and collecting the cooled third flow of the eluate.

5. The method according claim 4, additionally comprising:
producing at least one more flow of PLP water at one more selected temperature;
flowing the at least one more flow of PLP water through the first temperature-controlled pressure-resistant column thereby producing at least one more flow of the eluate therefrom, said eluate containing the one or more components;
cooling the at least one more flow of the eluate; and collecting the cooled at least one more flow of the eluate.

6. The method according to claim 1, wherein the loaded sorbent is additionally packed into a second temperature-controlled pressure-resistant column, said second temperature-controlled pressure-resistant column sealably engaged with the first temperature-controlled pressure-resistant column to receive therefrom the flow of the eluate from the first temperature-controlled pressure-resistant column, maintaining the pressurized and heated flow of the eluant through the second temperature-controlled pressure-resistant column, collecting the flow of the eluant from the second temperature-controlled pressure-resistant column, and cooling the collected flow of the eluate.

7. The method according to claim 1, additionally comprising a step of further processing the eluate to produce a concentrate therefrom.

8. The method according to claim 1, additionally comprising a step of further processing the eluate to produce a dried powder therefrom.

9. The method according to claim 1, wherein the sorbent is a sorbent resin.

10. The method according to claim 9, wherein the sorbent resin is selected from the group consisting of poly(styrene-divinylbenzene) resins, poly(divinylbenzene resins, and crosslinked polyamide resins.

11. The method according to claim 1, wherein the sorbent is a silica bead sorbent or a molecular sieve or an activated carbon or a bentonite clay or a zirconium oxide or a naturally occurring zeolite or a synthetic zeolite or a diatomaceous earth.

12. The method according to claim 1, wherein the sorbent is a silica gel or a bonded C₁-C₁₈ silica of a magnesium silicate.
